(19) United States
(12) Patent Application Publication
(10) Pub. No.: US 2026/0024441 A1
(43) Pub. Date: Jan. 22, 2026

(54) TRAFFIC ANALYSIS AND CONTROL FRAMEWORK FOR INLAND WATERWAYS USING SATELLITE IMAGERY

(71) Applicants: Ruijie Zeng, Chandler, AZ (US); Zhongxing Deng, Tempe, AZ (US); Elizabeth Eason, Parkville, MO (US); Chuncheng Yao, Tempe, AZ (US)

(72) Inventors: Ruijie Zeng, Chandler, AZ (US); Zhongxing Deng, Tempe, AZ (US); Elizabeth Eason, Parkville, MO (US); Chuncheng Yao, Tempe, AZ (US)

(73) Assignee: Arizona Board of Regents on Behalf of Arizona State University, Scottsdale, AZ (US)

(21) Appl. No.: 19/275,757

(22) Filed: Jul. 21, 2025

Related U.S. Application Data
(60) Provisional application No. 63/674,078, filed on Jul. 22, 2024.

(51) Int. Cl. G08G 3/00

(52) U.S. Cl. CPC G08G 3/00

(57) ABSTRACT

A computer-implemented system processes remote sensing data to detect and monitor barge traffic in inland waterways. The system obtains remote sensing data representing at least a portion of a waterway region and identifies candidate objects within the waterway region. The system classifies the candidate objects to differentiate barge-related features from other features and filters the barge-related features based on one or more criteria to produce filtered barge-related features. Position information for the filtered barge-related features is determined, and a movement status is classified based on the position information, wherein the movement status indicates at least one of: upbound, downbound, or stationary. In response to classifying the movement status, the system outputs barge monitoring data including the filtered barge-related features, the position information, and the movement status. The barge monitoring data may be used for analysis, visualization, or further processing in downstream systems.

### CLAIM OF PRIORITY

This U.S. Utility patent application claims the benefit of U.S. Provisional Patent Application No. 63/674,078, filed 22 Jul. 2024, the entire contents of which is incorporated herein by reference.

### TECHNICAL FIELD

Aspects of the disclosure relate generally to geospatial data processing, traffic monitoring, and control systems. More particularly, examples of the disclosure involve analyzing and managing traffic in inland waterway transportation networks using satellite imagery and remote sensing data.

### BACKGROUND

Inland waterways such as the Mississippi River are vital transportation routes for bulk goods, including agricultural commodities. Barges are commonly used for inland shipping and are often arranged into fleets pushed by motorized vessels. Monitoring barge traffic on inland waterways is important for operational safety, logistics management, and infrastructure planning.

Existing vessel tracking systems, such as the Automatic Identification System (AIS), provide location data for motorized vessels. However, AIS is typically not installed on non-motorized barges, resulting in incomplete visibility into total waterway traffic. As a result, current tracking systems do not consistently provide comprehensive data on barge movements. Supplemental traffic monitoring methods include manual reporting at locks, ports, or checkpoints. These approaches can introduce delays, create data gaps, and lack continuous spatial coverage. Additionally, general-purpose remote sensing techniques have been used in various geospatial monitoring applications but are not specifically adapted for tracking barge traffic on inland waterways.

### SUMMARY

In general, this disclosure is directed to systems, methods, and apparatuses for detecting, tracking, and monitoring barge traffic in inland waterways using remote sensing data and computer-implemented analytics. According to various examples, processing circuitry is configured to obtain remote sensing data that represents at least a portion of a waterway region. In certain examples, the system may be configured to monitor an expanded geographic domain, including not only the Mississippi River but also tributary systems such as the Ohio River and Illinois River. This expanded monitoring can support upstream and downstream traffic assessments, particularly in regions closer to agricultural production zones where drought impacts may be more pronounced.

The system processes the remote sensing data to identify candidate objects present within the waterway region. The system then classifies the candidate objects to distinguish barge-related features from other features, such as natural river elements or background structures. The barge-related features are filtered using one or more criteria to produce a set of filtered barge-related features that are likely to represent actual barges. Position information is determined for the filtered barge-related features, such as location or coordinates. A movement status is classified for each of the filtered barge-related features based on the position information, where the movement status may include, for example, upstream movement, downstream movement, or stationary parking in the waterway. In response to classifying the movement status, the system outputs barge monitoring data that includes the filtered barge-related features, the corresponding position information, and the classified movement status for each detected barge. The described techniques can provide automated insights for river traffic monitoring, logistics management, and situational awareness.

In at least one example, processing circuitry is configured to perform a method including: obtaining, using processing circuitry, remote sensing data representing at least a portion of a waterway region. In at least one example, the method includes processing, using the processing circuitry, the remote sensing data to identify candidate objects within the waterway region. According to certain examples, the method includes classifying, using the processing circuitry, the candidate objects to differentiate barge-related features from other features in the waterway region. In one example, the method includes filtering, using the processing circuitry, the barge-related features based on one or more criteria to produce filtered barge-related features. In at least one example, the method includes determining, using the processing circuitry, position information for the filtered barge-related features. According to such examples, the method includes classifying, using the processing circuitry, a movement status of the filtered barge-related features based on the position information, wherein the movement status indicates at least one of: upbound, downbound, or stationary. In one example, the method includes, in response to classifying the movement status of the filtered barge-related features, outputting, using the processing circuitry, barge monitoring data including the filtered barge-related features, the position information, and the movement status.

In at least one example, a system includes processing circuitry; non-transitory computer readable media; and instructions that, when executed by the processing circuitry, configure the processing circuitry to perform operations. In such an example, processing circuitry may configure the system to: obtain remote sensing data representing at least a portion of a waterway region. In one example, the system includes instructions that, when executed by the processing circuitry, configure the processing circuitry to process the remote sensing data to identify candidate objects within the waterway region. In at least one example, the system includes instructions that, when executed by the processing circuitry, configure the processing circuitry to classify the candidate objects to differentiate barge-related features from other features in the waterway region. According to such examples, the system includes instructions that, when executed by the processing circuitry, configure the processing circuitry to filter the barge-related features based on one or more criteria to produce filtered barge-related features. In one example, the system includes instructions that, when executed by the processing circuitry, configure the processing circuitry to determine position information for the filtered barge-related features. In at least one example, the system includes instructions that, when executed by the processing circuitry, configure the processing circuitry to classify a movement status of the filtered barge-related features based on the position information, wherein the movement status indicates at least one of: upbound, downbound, or stationary. According to certain examples, the system includes instructions that, when executed by the processing circuitry, configure the processing circuitry, in response to classifying the movement status of the filtered barge-related features, to output barge monitoring data including the filtered barge-related features, the position information, and the movement status.

In one example, there is computer-readable storage media having instructions that, when executed, configure processing circuitry to: obtain remote sensing data representing at least a portion of a waterway region. In at least one example, the non-transitory computer-readable storage medium stores instructions that, when executed by the processing circuitry, cause the processing circuitry to process the remote sensing data to identify candidate objects within the waterway region. According to certain examples, the non-transitory computer-readable storage medium stores instructions that, when executed by the processing circuitry, cause the processing circuitry to classify the candidate objects to differentiate barge-related features from other features in the waterway region. In one example, the non-transitory computer-readable storage medium stores instructions that, when executed by the processing circuitry, cause the processing circuitry to filter the barge-related features based on one or more criteria to produce filtered barge-related features. In at least one example, the non-transitory computer-readable storage medium stores instructions that, when executed by the processing circuitry, cause the processing circuitry to determine position information for the filtered barge-related features. According to such examples, the non-transitory computer-readable storage medium stores instructions that, when executed by the processing circuitry, cause the processing circuitry to classify a movement status of the filtered barge-related features based on the position information, wherein the movement status indicates at least one of: upbound, downbound, or stationary. In one example, the non-transitory computer-readable storage medium stores instructions that, when executed by the processing circuitry, cause the processing circuitry, in response to classifying the movement status of the filtered barge-related features, to output barge monitoring data including the filtered barge-related features, the position information, and the movement status.

In one example, a device includes means for obtaining, using processing circuitry, remote sensing data representing at least a portion of a waterway region. In at least one example, the device includes means for processing, using the processing circuitry, the remote sensing data to identify candidate objects within the waterway region. According to certain examples, the device includes means for classifying, using the processing circuitry, the candidate objects to differentiate barge-related features from other features in the waterway region. In one example, the device includes means for filtering, using the processing circuitry, the barge-related features based on one or more criteria to produce filtered barge-related features. In at least one example, the device includes means for determining, using the processing circuitry, position information for the filtered barge-related features. According to such examples, the device includes means for classifying, using the processing circuitry, a movement status of the filtered barge-related features based on the position information, wherein the movement status indicates at least one of: upbound, downbound, or stationary. In one example, the device includes means for outputting, using the processing circuitry, barge monitoring data including the filtered barge-related features, the position information, and the movement status in response to classifying the movement status of the filtered barge-related features.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of an example computing device, in accordance with aspects of this disclosure.

FIG. 2 depicts a satellite image fragment, in accordance with aspects of this disclosure.

FIG. 3 illustrates a table that provides a summary of raw multispectral image data obtained from PlanetScope systems, including PSB.SD sensors deployed from 2021 onward, in accordance with aspects of this disclosure.

FIG. 4 illustrates a satellite image fragment and a navigation mask, in accordance with aspects of this disclosure.

FIG. 5 illustrates an input raster image and a grayscale transformed raster image, in accordance with aspects of this disclosure.

FIG. 6 illustrates a near-infrared raster input and a thresholded binary mask, in accordance with aspects of this disclosure.

FIG. 7 illustrates an input segmented image and a binary mask after reclassification, in accordance with aspects of this disclosure.

FIG. 8 illustrates an input binary mask and a vectorized features output, in accordance with aspects of this disclosure.

FIG. 9 illustrates barge detection filter operations and barge centroid extraction operations, in accordance with aspects of this disclosure.

FIG. 10 illustrates a satellite image fragment including a river surface region and a barge fleet, in accordance with aspects of this disclosure.

FIG. 11A illustrates national freight transportation patterns across the United States, showing annual freight tonnage distribution by different transportation modes, in accordance with aspects of this disclosure.

FIG. 11B illustrates grain transport patterns between the Upper Mississippi River region and Louisiana, focusing on waterborne freight versus rail transport, in accordance with aspects of this disclosure.

FIG. 12 depicts bulk commodity shipping data for the Mississippi River, in accordance with aspects of this disclosure.

FIG. 13 depicts a grain shipment time series chart, which illustrates barge movements on the Mississippi River based on data from Locks 27 in Granite City, Illinois, in accordance with aspects of this disclosure.

FIG. 14 depicts example barge shipping infrastructure and transportation cost comparisons, in accordance with aspects of this disclosure.

FIG. 15 depicts limitations on marine AIS data for barge traffic, in accordance with aspects of this disclosure.

FIG. 16 illustrates a Mississippi river gauge chart, in accordance with aspects of this disclosure.

FIG. 17 depicts seasonal impacts on the Mississippi River near Memphis, Tennessee, including impacts on barge traffic, in accordance with aspects of this disclosure.

FIGS. 18A, 18B, 18C, and 18D depict agricultural supply chain disruptions and price shocks, in accordance with aspects of this disclosure.

FIG. 19 depicts different temporal patterns of the 2022 and 2023 droughts, in accordance with aspects of this disclosure.

FIG. 20 depicts different example planet imagery data providing binary classification of water surfaces and non-water surfaces, in accordance with aspects of this disclosure.

FIG. 21 depicts a convex hull visualization applied to portions of planet imagery data collection, in accordance with aspects of this disclosure.

FIG. 22 depicts a pipelined workflow performed by a barge tracking framework, in accordance with aspects of this disclosure.

FIG. 23 depicts validation and labeling performed by a barge tracking framework, in accordance with aspects of this disclosure.

FIG. 24 depicts an example of barge numbers and a fleet size summary provided by a barge tracking framework, in accordance with aspects of this disclosure.

FIG. 25 depicts an example of categorical barge traffic types for detailed analysis as provided by a barge tracking framework, in accordance with aspects of this disclosure.

FIG. 26 is a flow diagram illustrating an example method for detecting, classifying, and monitoring barge traffic in inland waterways using remote sensing data, in accordance with aspects of this disclosure.

Like reference characters denote like elements throughout the text and figures.

### DETAILED DESCRIPTION

In general, this disclosure is directed to systems, methods, and apparatuses for detecting, tracking, and monitoring barge traffic in inland waterways using remote sensing data and computer-implemented analytics. According to various examples, processing circuitry is configured to obtain remote sensing data that represents at least a portion of a waterway region. The system processes the remote sensing data to identify candidate objects present within the waterway region. The system then classifies the candidate objects to distinguish barge-related features from other features, such as natural river elements or background structures. The barge-related features are filtered using one or more criteria to produce a set of filtered barge-related features that are likely to represent actual barges. Position information is determined for the filtered barge-related features, such as location or coordinates. A movement status is classified for each of the filtered barge-related features based on the position information, where the movement status may include, for example, upstream movement, downstream movement, or stationary parking in the waterway. In response to classifying the movement status, the system outputs barge monitoring data that includes the filtered barge-related features, the corresponding position information, and the classified movement status for each detected barge. The described techniques can provide automated insights for river traffic monitoring, logistics management, and situational awareness in navigable waterways.

The described systems and methods implement a pipelined analytics approach for near real-time tracking of barge traffic in inland waterways using satellite remote sensing. For example, computer-implemented techniques enable automated detection of barges, with examples described in the context of the Mississippi River. Using remote sensing technology and geospatial analysis, the system provides a solution for monitoring river traffic and supporting logistical operations. A navigation map provided by the United States Army Corps of Engineers (USACE) may define the monitoring area, serving as a mask for collecting multispectral satellite imagery from providers such as Planet Labs. Pre-processing operations on the collected imagery include extraction of Near-Infrared (NIR) bands, segmentation of the NIR data, and binary thresholding to delineate potential barge locations. Further processing may involve Raster to Polygon conversion followed by selection-based filtering to isolate detected objects that meet specific criteria indicative of barge presence. Filtering conditions can include binary threshold tags, area constraints, and logical operators to differentiate between genuine barges and spurious detections. Automating these processes enhances operational efficiency, can reduce manual intervention in various implementations, and provides actionable insights for river traffic management, logistics optimization, and environmental monitoring.

Hydrologic variability and climatic extremes have placed stress on the reliability of arterial inland waterways such as the Mississippi River. Seasonal low-flow conditions during the grain harvest and transport season, typically from mid-October to mid-November, require careful management of navigation infrastructure and barge fleet arrangements. Recent drought conditions have impacted navigation capacity, motivating improvements in monitoring systems and caused barge shipping prices to spike, disrupting agricultural supply chains and threatening global food security. For example, the barge shipping rate at the St. Louis barge spot increased from a historical average of $20 per ton to $106 per ton within one week in October 2022.

Conventional monitoring methods, such as the Automatic Identification System (AIS), partially address vessel tracking but are limited to motorized vessels. These systems do not track non-motorized barges, which represent a significant portion of river traffic. The inability to monitor non-motorized barges creates challenges for assessing traffic patterns, coordinating fleet movements, and increasing safety. Given these limitations, there is a need for solutions capable of tracking both motorized and non-motorized barges, including in various examples where non-motorized barge traffic is monitored.

The disclosed techniques bridge this information gap by providing near real-time barge monitoring that can help the agricultural supply chain mitigate the impacts of drought and river congestion. Use cases include agricultural product traders and producers, barge transportation companies, and agricultural insurance providers.

AIS-only systems typically do not track non-motorized barges, creating potential limitations in traffic visibility. Conversely the disclosed technology detects various types of barges in a manner that can reduce operational disruption, which can enable improved safety, efficiency, and cost reduction in various implementations.

Multispectral satellite imagery coupled with advanced image processing algorithms enables the system to identify and monitor both motorized and non-motorized barges with improved accuracy. This remote sensing approach allows for wide-area, non-invasive monitoring, addressing certain limitations of conventional methods and providing new approaches to waterway traffic management.

Benefits of the disclosed techniques include monitoring of multiple types of barges, including motorized and non-motorized, in various examples, non-invasive implementation without requiring onboard equipment, improved accuracy and efficiency for real-time detection, and wide coverage of expansive river networks. These capabilities support applications in agriculture, transportation, commerce, and environmental management.

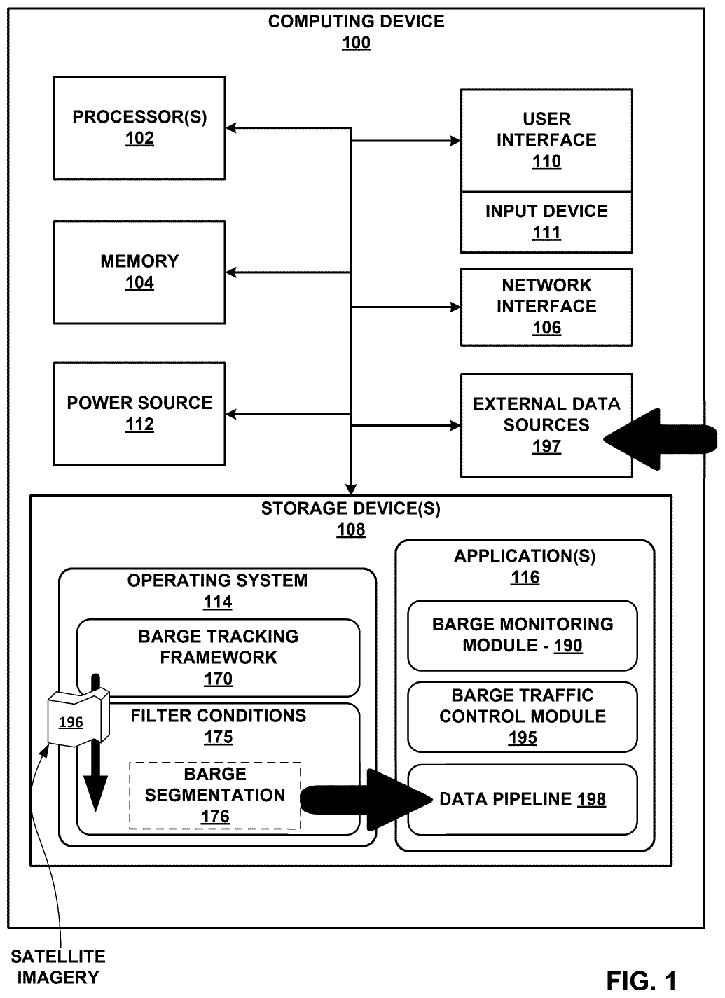

FIG. 1 is a block diagram illustrating further details of one example of a computing device, in accordance with aspects of this disclosure. FIG. 1 illustrates only one particular example of computing device 100. Many other examples of computing device 100 may be used in other instances.

As shown in the specific example of FIG. 1, computing device 100 may include one or more processors 102, memory 104, a network interface 106, one or more storage devices 108, a user interface 110, and a power source 112. Computing device 100 may also include an operating system 114. Computing device 100, in one example, may further include one or more applications 116, including barge monitoring module 190, barge traffic control module 195, and data pipeline 198.

Operating system 114 may execute various functions including barge tracking framework 170. Barge tracking framework 170 may be configured to obtain and process satellite imagery 196 and may also receive external data sources 197. External data sources 197 may include, for example, vessel identification data, environmental data, hydrologic data, traffic reports, or any other relevant geospatial information.

In certain examples, barge tracking framework 170 may be configured to combine external data sources 197 with satellite-based detection outputs to enhance monitoring capabilities. For instance, vessel identification data such as AIS signals may be compared with barge detections from satellite imagery to validate or refine movement status classifications. In cases where non-motorized barges lack AIS transmitters, the system can provide complementary detection based on remote sensing imagery. Additionally, hydrologic data such as river gauge measurements can be incorporated to assess the impacts of low-water conditions on barge movement patterns, and environmental data may be used to predict or contextualize shipping delays. This multimodal data integration can support comprehensive river traffic monitoring, improved decision support for logistics management, and enhanced situational awareness.

Barge tracking framework 170 may apply filter conditions 175 to the received data to support traffic monitoring processes. Filter conditions 175 may include parameters for data extraction, object detection, or classification. Barge tracking framework 170 may perform barge segmentation 176, generating segmented data corresponding to potential barge targets or related waterway objects. The segmented data may be provided to data pipeline 198 for further processing, analysis, reporting, or integration into downstream systems.

Applications 116 may utilize data from barge segmentation 176 and data pipeline 198. For example, barge monitoring module 190 and barge traffic control module 195 may process data from data pipeline 198 to support monitoring, control, and management of traffic, environmental, or safety considerations on navigable waterways.

In some examples, processing circuitry including one or more processors 102 implements functionality and/or process instructions for execution within computing device 100. For example, one or more processors 102 may be capable of processing instructions stored in memory 104 and/or instructions stored on one or more storage devices 108.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memories (RAM), dynamic random-access memories (DRAM), static random-access memories (SRAM), and other forms of volatile memories. In some examples, memory 104 may be used to store program instructions for execution by one or more processors 102. Memory 104, in one example, may be used by software or applications running on computing device 100 (e.g., one or more applications 116) to temporarily store data and/or instructions during program execution.

One or more storage devices 108, in some examples, may also include one or more computer-readable storage media. One or more storage devices 108 may be configured to store larger amounts of information than memory 104. One or more storage devices 108 may further be configured for long-term storage of information. In some examples, one or more storage devices 108 may include non-volatile storage elements. Examples of such non-volatile storage elements may include magnetic hard disks, optical discs, floppy disks, Flash memories, or forms of electrically programmable memories (EPROM) or electrically erasable and programmable (EEPROM) memories.

Computing device 100, in some examples, may also include network interface 106. Computing device 100, in such examples, may use network interface 106 to communicate with external devices via one or more networks, such as one or more wired or wireless networks. Network interface 106 may be a network interface card, such as an Ethernet card, an optical transceiver, a radio frequency transceiver, a cellular transceiver, or any other type of device that can send and receive information. Other examples of such network interfaces may include BLUETOOTH®, 3G, 4G, 1G, LTE, and WI-FI® radios in mobile computing devices as well as USB. In some examples, computing device 100 may use network interface 106 to wirelessly communicate with an external device such as a server, mobile phone, or other networked computing device.

Computing device 100 may also include user interface 110. User interface 110 may include one or more input devices 111, such as a touch-sensitive display. Input device 111, in some examples, may be configured to receive input from a user through tactile, electromagnetic, audio, and/or video feedback. Examples of input device 111 may include a touch-sensitive display, mouse, keyboard, voice responsive system, video camera, microphone, or any other type of device for detecting gestures by a user. In some examples, a touch-sensitive display may include a presence-sensitive screen.

User interface 110 may also include one or more output devices, such as a display screen of a computing device or a touch-sensitive display, including a touch-sensitive display of a mobile computing device. One or more output devices, in some examples, may be configured to provide output to a user using tactile, audio, or video stimuli. One or more output devices, in one example, may include a display, sound card, a video graphics adapter card, or any other type of device for converting a signal into an appropriate form understandable to humans or machines. Additional examples of one or more output devices may include a speaker, a cathode ray tube (CRT) monitor, a liquid crystal display (LCD), or any other type of device that can generate intelligible output to a user.

Computing device 100, in some examples, may include power source 112, which may be rechargeable and provide power to computing device 100. Power source 112, in some examples, may be a battery made from nickel-cadmium, lithium-ion, or other suitable material.

Examples of computing device 100 may include operating system 114. Operating system 114 may be stored in one or more storage devices 108 and may control the operation of components of computing device 100. For example, operating system 114 may facilitate the interaction of one or more applications 116 with hardware components of computing device 100.

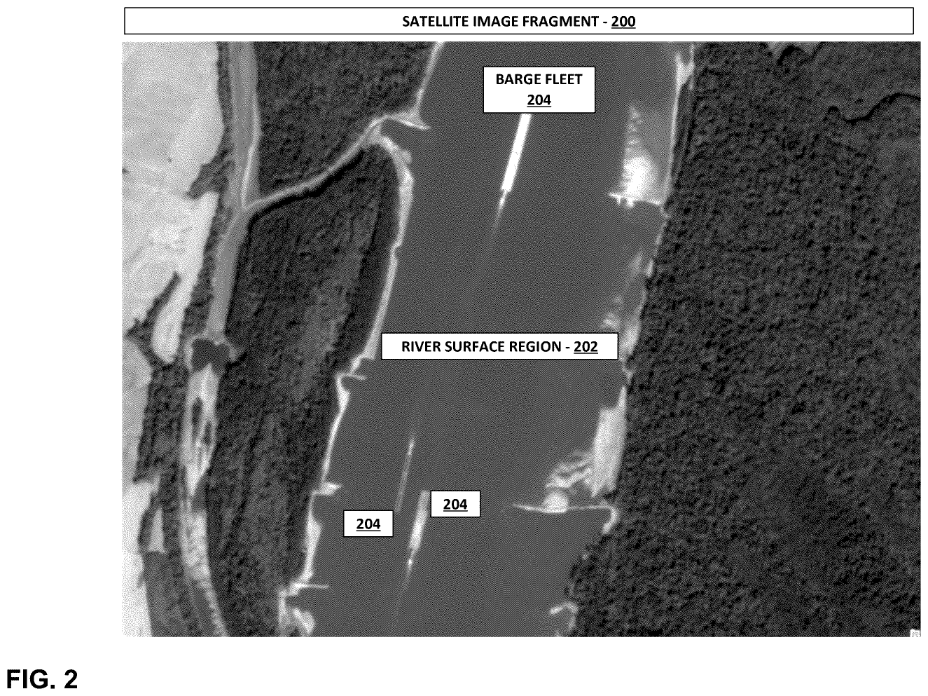

FIG. 2 depicts a satellite image fragment 200, in accordance with aspects of this disclosure. Satellite image fragment 200 may represent a portion of a larger multispectral or Near-Infrared (NIR) image collected from satellite imagery. In the example shown, satellite image fragment 200 includes a river surface region 202 and one or more barge fleets 204.

River surface region 202 corresponds to a portion of an inland waterway, such as the Mississippi River or other navigable river system. The river surface region 202 may be identified in satellite imagery based on spectral characteristics, such as reflectance or absorption in specific wavelengths.

Barge fleet 204 represents a collection of one or more barges detected within the river surface region 202. In the example shown, the barge fleet 204 is visible as a set of bright, rectangular shapes positioned within the waterway. Barge fleet 204 may include multiple non-motorized barges arranged together and pushed by a tow vessel, although the individual propulsion components may not be visible in the image fragment.

Satellite image fragment 200 may be processed by barge tracking framework 170, as described with respect to FIG. 1, to perform further segmentation and classification of the detected objects.

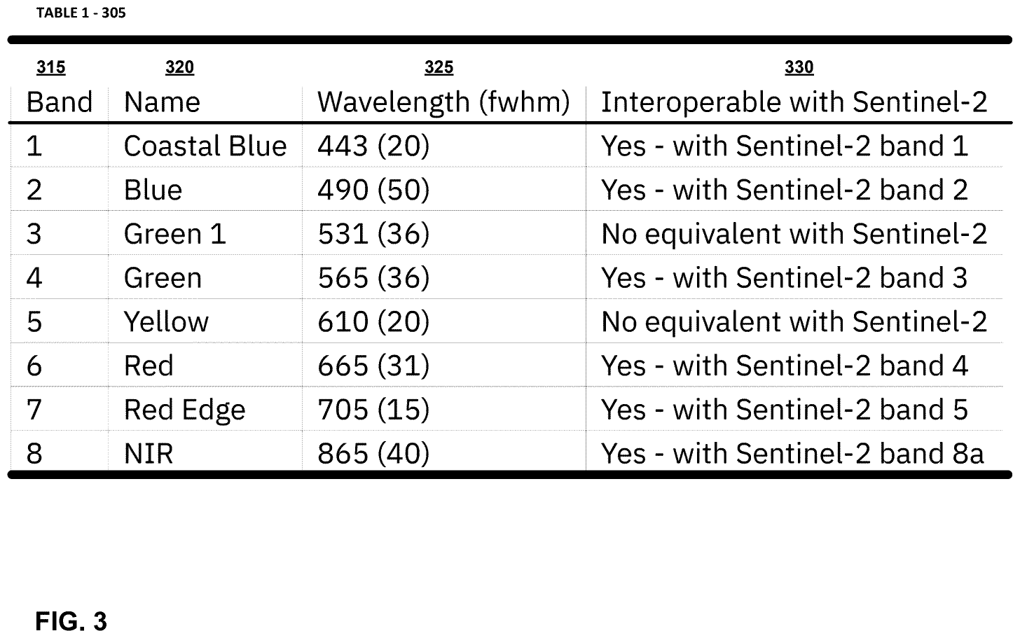

FIG. 3 illustrates table 1 at element 305, which provides a summary of raw multispectral image data obtained from PlanetScope systems, including PSB.SD sensors deployed from 2021 onward, in accordance with aspects of this disclosure. Table 1 (element 305) details the multispectral sensor performance across eight spectral bands. For example, the near-infrared (NIR) band is represented as reference number 315 in Table 1, row 8. This NIR band can be used for distinguishing water surfaces from barge surfaces based on spectral reflectance differences, as described in subsequent processing steps.

Each band is listed in a band column 320, including Coastal Blue, Blue, Green I, Green, Yellow, Red, Red Edge, and NIR. The wavelength column 325 specifies the central wavelength in nanometers and the full width at half maximum (FWHM) for each band. The FWHM represents the width of the spectral peak at half of its maximum amplitude, providing a measure of sensor sensitivity for each band.

The interoperability column 330 indicates whether each spectral band aligns with Sentinel-2 satellite bands. For example, the Coastal Blue band is interoperable with Sentinel-2 band 1, and the NIR band is interoperable with Sentinel-2 band 8a. Some bands, such as Green I and Yellow, do not have equivalents in the Sentinel-2 system.

In some examples, barge tracking framework 170 may utilize the multispectral bands summarized in table 1 (305) for detecting inland waterway traffic. Barge tracking framework 170 may also apply a navigation map mask to define a monitoring area over the Mississippi River or other navigable waterways. For example, navigation maps from the United States Army Corps of Engineers (USACE) may be accessed via the iencclouds.us.gov service using tools such as ArcGIS Pro.

In certain cases, barge tracking framework 170 may select Depth_Area map services under IENC_Feature_Classes and identify objects with a Depth_Area_Value greater than 2.74. The selected data may be exported as shapefiles to serve as masks for navigable waterway regions.

The navigation mask may be applied as a spatial filter to extract relevant portions of the multispectral satellite imagery obtained from Planet Labs or other sources. In these examples, barge tracking framework 170 may be configured such that the imagery includes at least four spectral bands, such as Red, Green, Blue, and Near-Infrared (NIR), for use in barge detection, segmentation, and analysis.

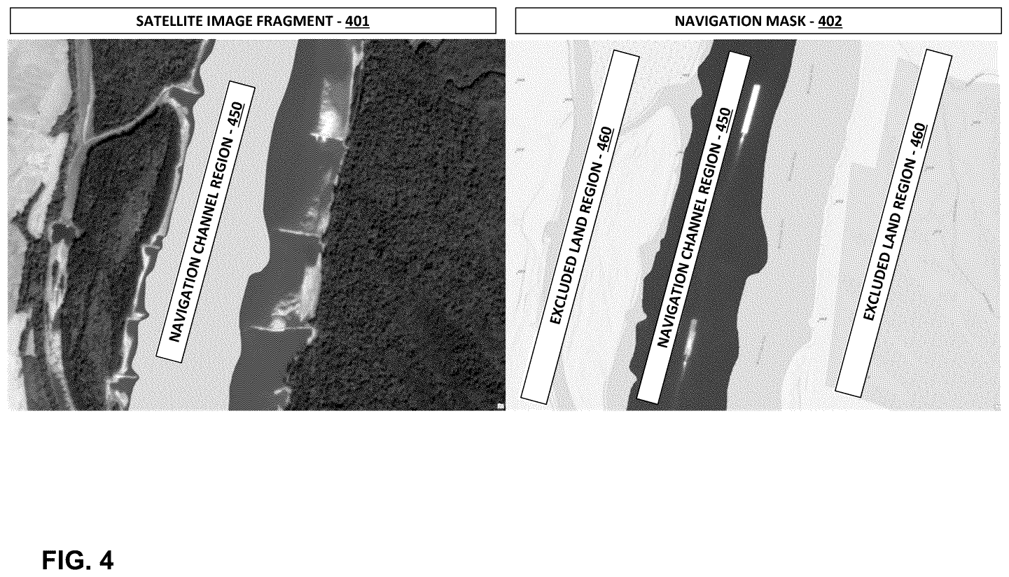

FIG. 4 illustrates satellite image fragment 401 and navigation mask 402, in accordance with aspects of this disclosure. Satellite image fragment 401 represents raw multispectral imagery obtained from satellite sources. In the example shown, satellite image fragment 401 includes navigation channel region 450, which corresponds to a monitored waterway area, such as the Mississippi River.

Navigation mask 402 is derived from a navigation map provided by the United States Army Corps of Engineers (USACE). Navigation mask 402 is generated by loading the navigation map into a geospatial processing environment, such as ArcGIS Pro, and overlaying the navigation map onto satellite image fragment 401 to provide or increase spatial alignment.

Navigation mask 402 includes navigation channel region 450 and excluded land region 460. Navigation channel region 450 corresponds to the designated navigable waterway areas identified in the USACE navigation map. Excluded land region 460 represents geographic regions outside the monitored waterway area, including adjacent land features, floodplains, or other non-navigable zones.

In some examples, barge tracking framework 170 may apply a clipping operation to confine analysis to navigation channel region 450. The clipping operation may involve specifying the extent of navigation mask 402 to isolate navigation channel region 450 from satellite image fragment 401, resulting in a clipped raster dataset that contains only relevant monitoring areas.

Barge tracking framework 170 may perform this raster data clipping operation using functionality provided by ArcGIS Pro or any equivalent geospatial processing tool. The operation may reduce computational load and focus subsequent processing steps on navigation channel region 450, while excluding excluded land region 460 from further analysis.

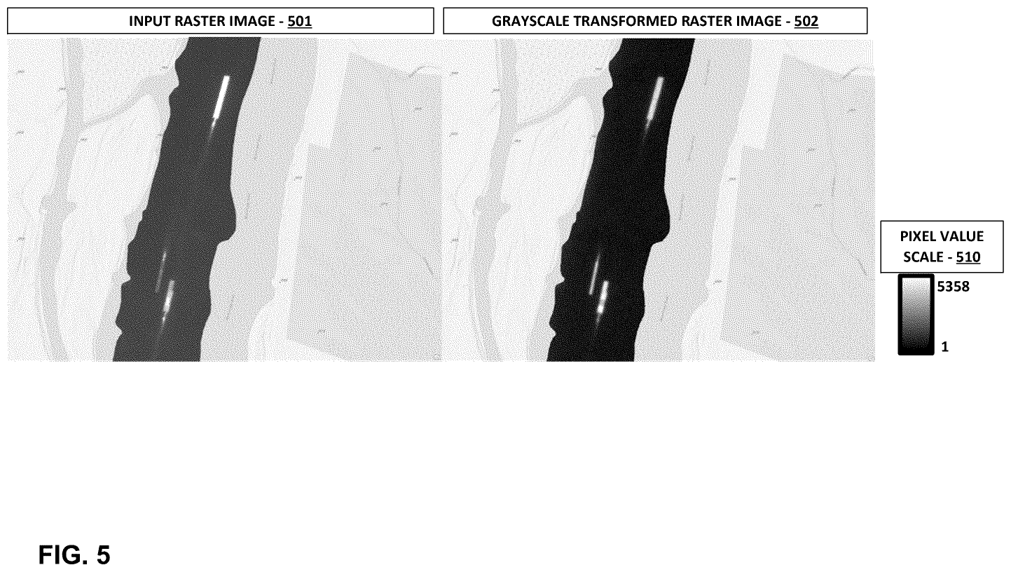

FIG. 5 illustrates input raster image 501 and grayscale transformed raster image 502, in accordance with aspects of this disclosure. Input raster image 501 represents the extracted Near-Infrared (NIR) band data from a multispectral raster dataset. Grayscale transformed raster image 502 depicts the result of applying a grayscale color scheme to input raster image 501, enhancing contrast and feature visibility.

Pixel value scale 510 indicates the range of NIR intensity values represented in grayscale transformed raster image 502. Pixel value scale 510 shows values ranging from 1 to 5358, where lower values correspond to darker shades and higher values correspond to lighter shades in grayscale transformed raster image 502.

In some examples, barge tracking framework 170 may extract Near-Infrared (NIR) bands from the clipped multispectral raster dataset generated in prior processing steps. The multispectral raster dataset may include Red, Green, Blue, and Near-Infrared (NIR) spectral bands. Barge tracking framework 170 may identify the NIR band, typically represented as Band 4 in PlanetScope imagery, known for its sensitivity to water content and vegetation health.

Barge tracking framework 170 may perform a band extraction operation using ArcGIS Pro or an equivalent geospatial tool to isolate the NIR band and generate input raster image 501. Barge tracking framework 170 may then assign a grayscale color scheme to input raster image 501 to produce grayscale transformed raster image 502, improving the visual differentiation between barges and surrounding water regions.

The enhanced contrast in grayscale transformed raster image 502 may facilitate identification of subtle variations in NIR reflectance, aiding subsequent segmentation and analysis processes.

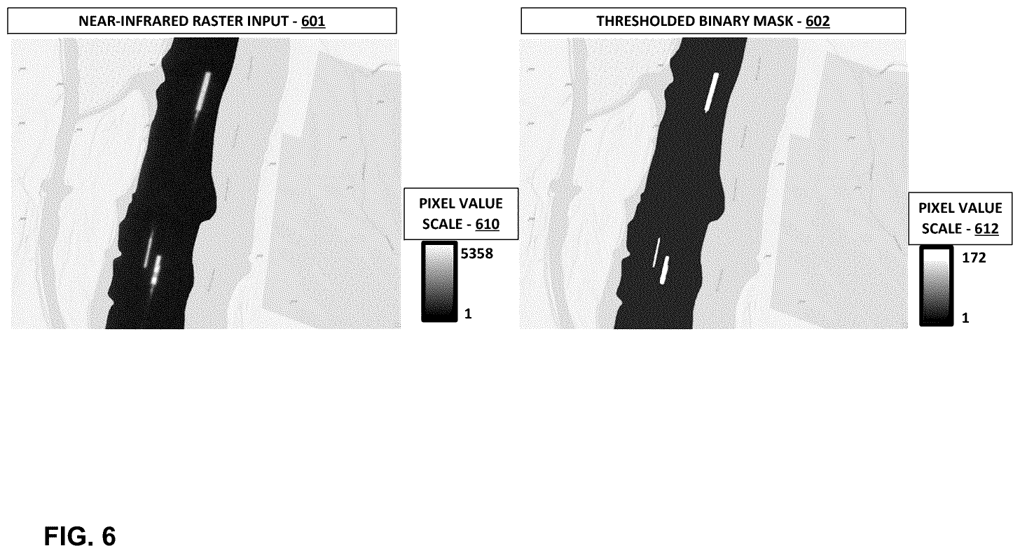

FIG. 6 illustrates near-infrared raster input 601 and thresholded binary mask 602, in accordance with aspects of this disclosure. Near-infrared raster input 601 represents a grayscale Near-Infrared (NIR) raster image extracted from prior processing steps. Thresholded binary mask 602 is generated by applying a segmentation and thresholding operation to near-infrared raster input 601, resulting in a partitioned image where distinct features are identified.

Pixel value scale 610 corresponds to near-infrared raster input 601 and indicates NIR intensity values ranging from 1 to 5358. Pixel value scale 610 visually represents the grayscale mapping of pixel values in near-infrared raster input 601.

Pixel value scale 612 corresponds to thresholded binary mask 602 and indicates pixel values ranging from 1 to 172. Pixel value scale 612 represents the binary or segmented pixel intensity levels resulting from the thresholding and partitioning process applied to near-infrared raster input 601.

In some examples, barge tracking framework 170 may perform segmentation of the NIR bands data to delineate distinct features within a monitoring area. This may involve applying a segmentation operation to near-infrared raster input 601 using image segmentation tools provided by ArcGIS Pro or equivalent geospatial processing tools.

Barge tracking framework 170 may configure segmentation parameters to control the output of the partitioning process. The spectral detail may be set to 8 to increase sensitivity to spectral variations, allowing for fine discrimination between different features. The spatial detail may be set to 5 to regulate the level of spatial smoothing, balancing edge preservation with noise reduction. The minimum segmentation size may be set to 20 to exclude small regions and suppress artifacts.

Barge tracking framework 170 may apply a thresholding operation to convert the segmented data into thresholded binary mask 602, where homogeneous regions corresponding to potential barge targets or other relevant features are isolated. Thresholded binary mask 602 may enable subsequent analysis steps to focus on barge-related patterns and river morphology features.

As output from the segmentation operations, barge tracking framework 170 may store thresholded binary mask 602 as a raster dataset in a suitable file format, preserving the segmented regions for downstream analysis in the barge detection workflow.

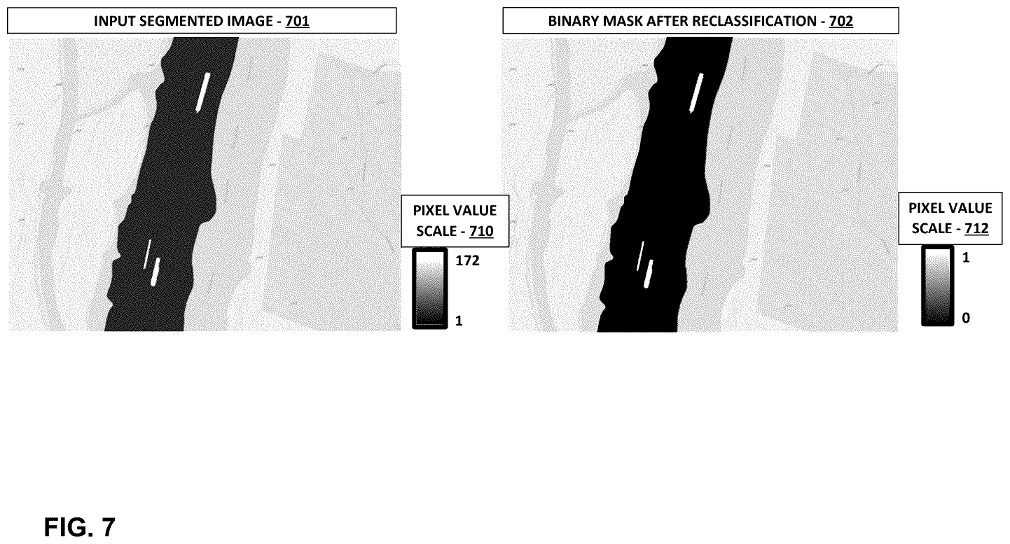

FIG. 7 illustrates input segmented image 701 and binary mask after reclassification 702, in accordance with aspects of this disclosure. Input segmented image 701 represents segmented raster data generated from prior processing operations. Binary mask after reclassification 702 is produced by applying a binary thresholding operation to input segmented image 701 to convert it into a two-class binary representation.

Pixel value scale 710 corresponds to input segmented image 701 and indicates pixel values ranging from 1 to 172. Pixel value scale 710 reflects the range of intensity levels in the segmented raster data prior to binary classification.

Pixel value scale 712 corresponds to binary mask after reclassification 702 and indicates pixel values of 0 and 1. In binary mask after reclassification 702, pixel value 1 represents potential barge-related features or relevant river elements, and pixel value 0 represents background regions or non-barge areas.

In some examples, barge tracking framework 170 may perform binary thresholding of segmented raster data to separate barge-related features from background elements. This process involves accessing input segmented image 701, which contains partitioned regions corresponding to potential barge locations and other river features.

Barge tracking framework 170 may utilize the binary thresholding tool in ArcGIS Pro or equivalent functionality to analyze the distribution of pixel intensities in input segmented image 701. The tool may automatically compute an optimal threshold by analyzing the histogram of pixel values and selecting a threshold that maximizes separation between foreground and background classes.

Barge tracking framework 170 may apply the determined threshold to classify pixels in input segmented image 701 into foreground and background categories, generating binary mask after reclassification 702. Pixels in binary mask after reclassification 702 classified as 1 may represent barge-related features or other relevant elements of interest, while pixels classified as 0 may correspond to non-barge areas or noise.

Barge tracking framework 170 may analyze binary mask after reclassification 702 to verify that the thresholding operation has effectively isolated potential barge locations. As output from this process, barge tracking framework 170 may save binary mask after reclassification 702 as a raster dataset in a suitable file format for use in subsequent steps of the barge detection workflow.

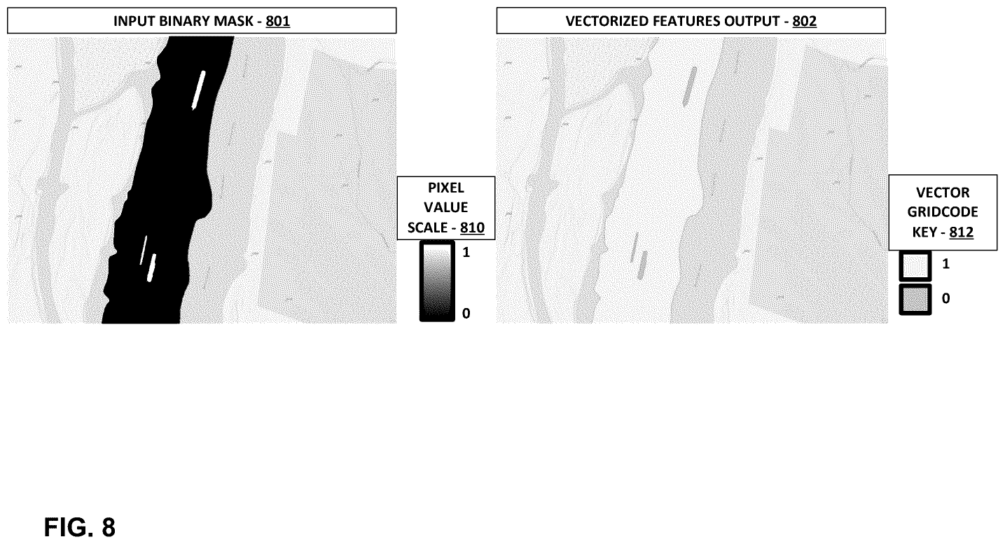

FIG. 8 illustrates input binary mask 801 and vectorized features output 802, in accordance with aspects of this disclosure. Input binary mask 801 represents a binary raster dataset where pixels have been classified into foreground and background elements from prior thresholding operations. Vectorized features output 802 corresponds to the polygonal feature class generated by converting input binary mask 801 into vector format.

Pixel value scale 810 corresponds to input binary mask 801 and represents pixel values of 0 and 1, where 1 indicates foreground features such as potential barge locations and 0 indicates background regions.

Vector gridcode key 812 corresponds to vectorized features output 802 and provides a reference mapping of polygon feature classifications. In vector gridcode key 812, gridcode 1 denotes vector polygons representing potential barge locations or relevant river features, and gridcode 0 denotes background polygons or non-barge areas.

In some examples, barge tracking framework 170 may utilize a Raster to Polygon conversion operation to transform input binary mask 801 into vectorized features output 802. This conversion may be performed using the Raster to Polygon tool provided in the ArcGIS Pro geoprocessing toolbox.

Barge tracking framework 170 may configure the Raster to Polygon tool by specifying input binary mask 801 as the input raster dataset and selecting an output destination for vectorized features output 802. Barge tracking framework 170 may optionally enable the Simplify Polygons function within the Raster to Polygon tool parameters to produce smoother edges in vectorized features output 802, reducing complexity and improving the visual clarity of the resulting vector geometries.

Barge tracking framework 170 may execute the Raster to Polygon operation, generating vectorized features output 802 where contiguous groups of foreground pixels from input binary mask 801 are converted into corresponding vector polygons. Vectorized features output 802 represents potential barge locations and relevant river features in a format suitable for downstream analysis, visualization, and further processing steps.

In some examples, barge tracking framework 170 may assign confidence scores or uncertainty indicators to the vectorized features output 802. These confidence scores may reflect factors such as the quality of the input imagery, the clarity of spectral separation in the near-infrared band, or the degree of alignment between detected features and expected barge dimensions. For example, vector polygons representing potential barge locations may include metadata fields specifying a detection confidence level. Similarly, barge centroid points 902 may include associated confidence values that quantify the likelihood of accurate positioning. These confidence indicators can assist downstream processes, enabling selective review of lower-confidence detections, automated prioritization of certain observations, or integration into broader decision support systems.

Barge tracking framework 170 may store vectorized features output 802 in a suitable geodatabase or file format, preserving the vector representation of features for later use in the barge monitoring and analysis workflow. In some examples, barge tracking framework 170 may provide output data through a web-based interface or an application programming interface (API). This interface can allow users to access barge tracking data, fleet summaries, and traffic classifications via client applications, dashboards, or automated decision support systems. Web or API-based delivery can enable real-time access to the monitoring results, supporting integration with logistics platforms, financial market analysis tools, or other downstream systems.

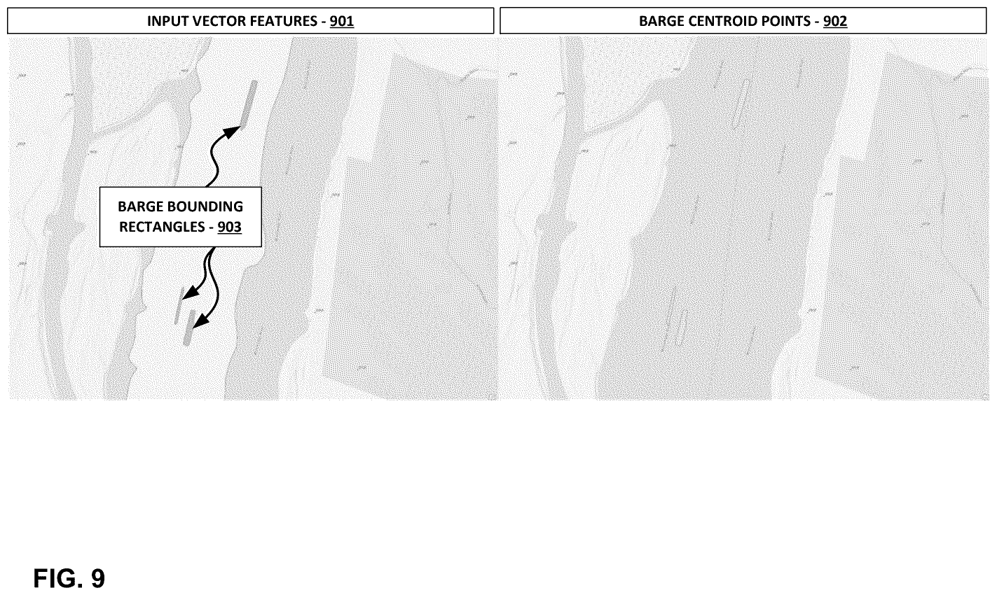

FIG. 9 illustrates barge detection filter operations and barge centroid extraction operations, in accordance with aspects of this disclosure. Barge tracking framework 170 may execute barge detection filter operations to refine the potential barge detections generated by prior vectorization processes. For example, barge tracking framework 170 may apply barge detection filter operations to input vector features 901 derived from prior raster-to-polygon conversion operations. Input vector features 901 include barge bounding rectangles 903 that represent preliminary barge candidate detections.

Barge tracking framework 170 may apply filter criteria to barge bounding rectangles 903 using attribute-based selection tools in ArcGIS Pro. For instance, barge tracking framework 170 may filter barge bounding rectangles 903 by evaluating a binary threshold tag associated with each candidate. Barge tracking framework 170 may retain barge bounding rectangles 903 that possess a binary threshold tag equal to 1, corresponding to initial barge detections. In addition, barge tracking framework 170 may filter barge bounding rectangles 903 based on area constraints. For example, barge tracking framework 170 may retain barge bounding rectangles 903 having an area greater than 200 m² to eliminate small false positives. Barge tracking framework 170 may further retain barge bounding rectangles 903 having an area less than 100,000 m² to exclude oversized objects unrelated to barges, such as land masses or river banks. Barge tracking framework 170 may combine these filtering conditions using an AND logical operator to produce a refined set of barge bounding rectangles 903.

After applying barge detection filter operations, barge tracking framework 170 may execute barge centroid extraction operations to determine spatial reference points for the refined barge detections. For example, barge tracking framework 170 may calculate centroid coordinates for each barge bounding rectangle 903 that passes the filter criteria. Barge tracking framework 170 may output barge centroid points 902 corresponding to the center points of the refined barge bounding rectangles 903.

Barge centroid points 902 may be saved as vector point features in an output data layer, enabling downstream processing such as barge tracking, trajectory analysis, or object counting within the monitored river segment.

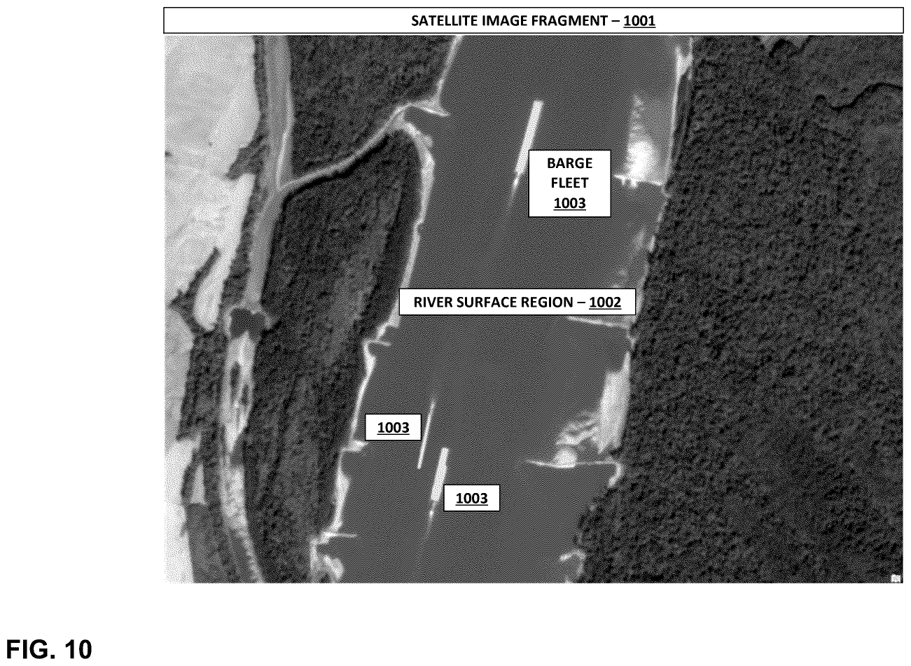

FIG. 10 illustrates satellite image fragment 1001 including river surface region 1002 and barge fleet 1003, in accordance with aspects of this disclosure. Satellite image fragment 1001 shows the final output after execution of barge detection and filtering operations performed by barge tracking framework 170. Barge tracking framework 170 processes multispectral satellite data to isolate barge fleet 1003 within river surface region 1002 using the series of operations described herein.

Barge tracking framework 170 applies filtering criteria to remove false positives and unrelated features, retaining detected targets corresponding to barge fleet 1003. As illustrated in satellite image fragment 1001, barge fleet 1003 includes multiple barge-like objects identified and preserved following the filtering operations.

Barge tracking framework 170 may export or save the filtered targets corresponding to barge fleet 1003 as a separate feature class or layer, storing the output for additional analysis, reporting, or visualization. The representation in satellite image fragment 1001 enables geospatial tracking and assessment of barge fleet 1003 over river surface region 1002 in a consistent, automated framework.

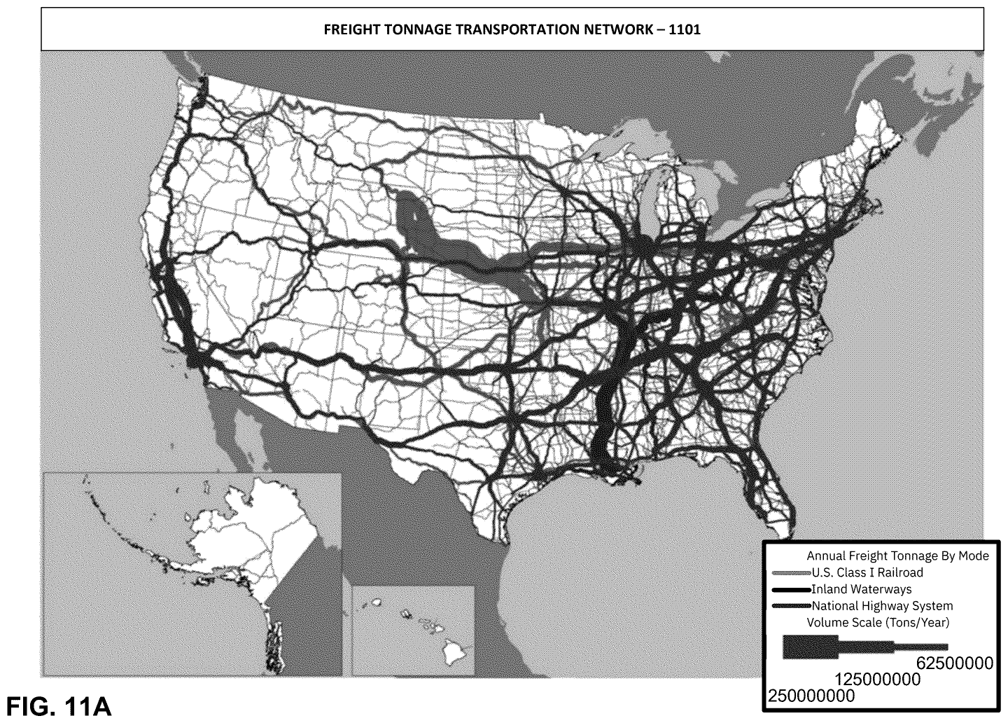

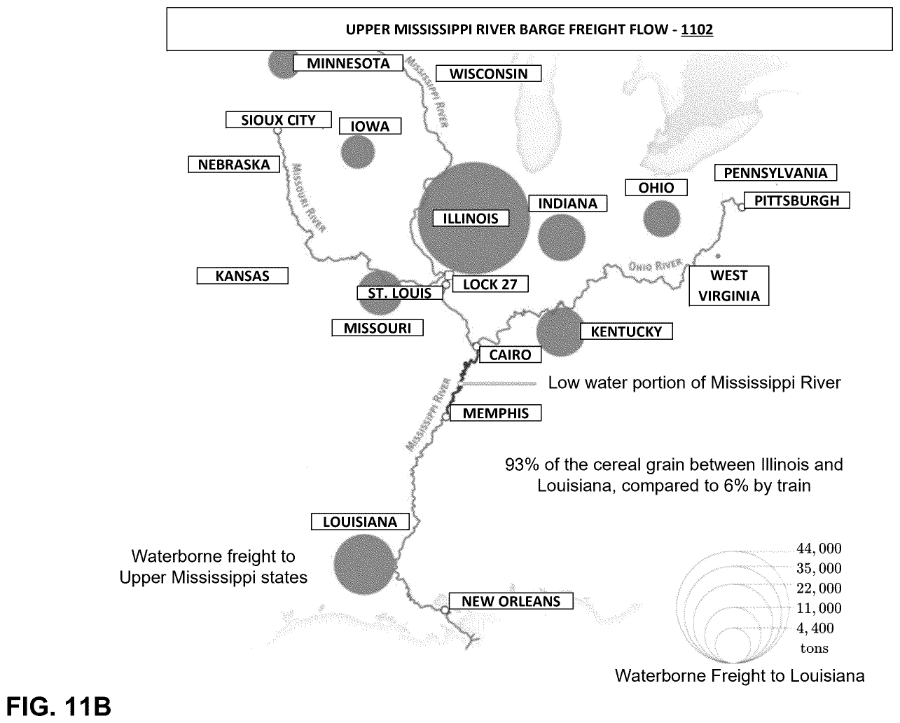

FIG. 11A illustrates national freight transportation patterns across the United States, showing annual freight tonnage distribution by different transportation modes, in accordance with aspects of this disclosure. FIG. 11A includes freight tonnage transportation network 1101, which comprises United States Class I railroad routes, national highway system routes, and inland waterways. Freight tonnage transportation network 1101 is visualized using varying line widths to indicate relative freight volume. Heavier lines in freight tonnage transportation network 1101 correspond to higher tonnage, as represented by volume scale 1102. Volume scale 1102 specifies a range of annual freight volumes in tons per year from 2,500,000 tons to 625,000,000 tons. Freight tonnage transportation network 1101 highlights dense freight activity in the eastern United States, particularly along the Mississippi River system where inland waterways carry significant tonnage volumes. Freight tonnage transportation network 1101 also illustrates major freight corridors in the western United States, including routes through California, Texas, and the Midwest.

FIG. 11B illustrates grain transport patterns between the Upper Mississippi River region and Louisiana, focusing on waterborne freight versus rail transport, in accordance with aspects of this disclosure. FIG. 11B includes upper Mississippi River barge freight flow 1102. Upper Mississippi River barge freight flow 1102 shows states including Minnesota, Iowa, Illinois, Missouri, Indiana, Kentucky, Ohio, West Virginia, and Louisiana, along with relevant cities and ports such as Minneapolis, St. Louis, Cairo, Memphis, and New Orleans. Upper Mississippi River barge freight flow 1102 includes grain shipping volumes represented by proportional circles 1104. Proportional circles 1104 visually indicate the relative volume of cereal grain transported from each state toward Louisiana. Waterborne grain transport to Louisiana is represented by the larger proportional circles 1104, while rail transport is comparatively smaller. Upper Mississippi River barge freight flow 1102 shows that 93% of cereal grain shipped between Illinois and Louisiana is transported via barge on inland waterways, with only 6% transported by rail. FIG. 11B includes freight mode comparison annotation 1105, which highlights the 93% to 6% modal split between barge and rail for grain transport. FIG. 11B also includes waterborne freight volume scale 1106, which provides a reference for interpreting proportional circles 1104, indicating waterborne freight volumes ranging from 4,400 tons to 44,000 tons.

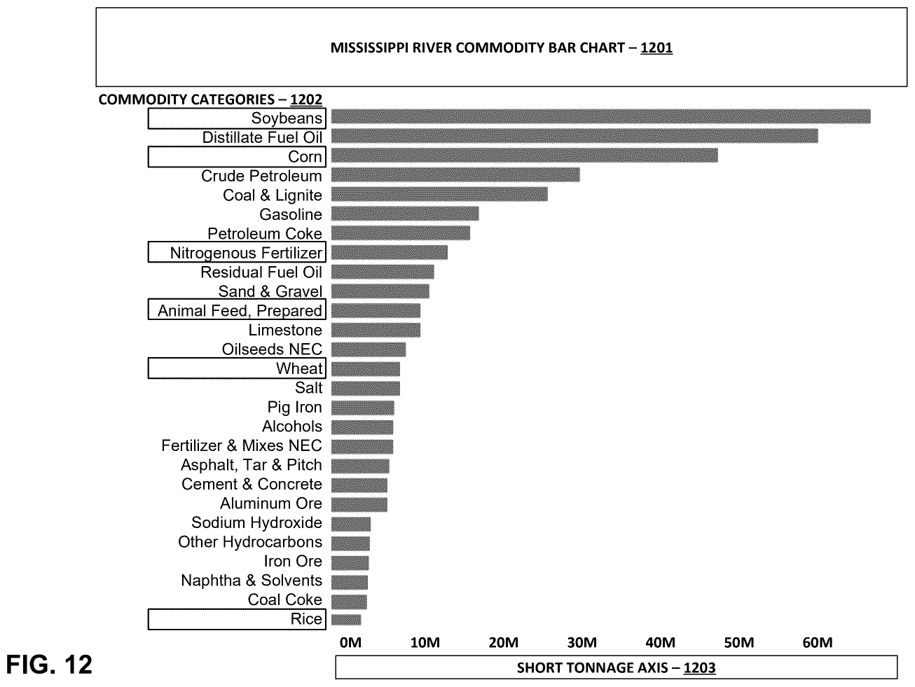

FIG. 12 depicts bulk commodity shipping data for the Mississippi River, in accordance with aspects of this disclosure. FIG. 12 includes Mississippi River commodity bar chart 1201. Mississippi River commodity bar chart 1201 shows annual commodity short ton volumes transported on the Mississippi River from Minneapolis, Minnesota to the Mouth of Passes, Louisiana. Mississippi River commodity bar chart 1201 includes commodity categories 1202, listing specific commodity groups such as soybeans, distillate fuel oil, corn, crude petroleum, coal and lignite, gasoline, petroleum coke, nitrogenous fertilizer, residual fuel oil, sand and gravel, animal feed prepared, limestone, oilseeds not elsewhere classified, wheat, salt, pig iron, alcohols, fertilizer and mixes not elsewhere classified, asphalt tar and pitch, cement and concrete, aluminum ore, sodium hydroxide, other hydrocarbons, iron ore, naphtha and solvents, coal coke, and rice. FIG. 12 further includes short tonnage axis 1203, showing tonnage volumes ranging from 0 million tons to 60 million tons per year.

In one example, bulk commodity shipping data visualized in Mississippi River commodity bar chart 1201 indicates that 43% of total tonnage consisted of corn, soybeans, wheat, and other grains. In another example, 22% of the total tonnage consisted of domestic petroleum and petroleum products, and 20% of the total tonnage consisted of coal used in electricity generation.

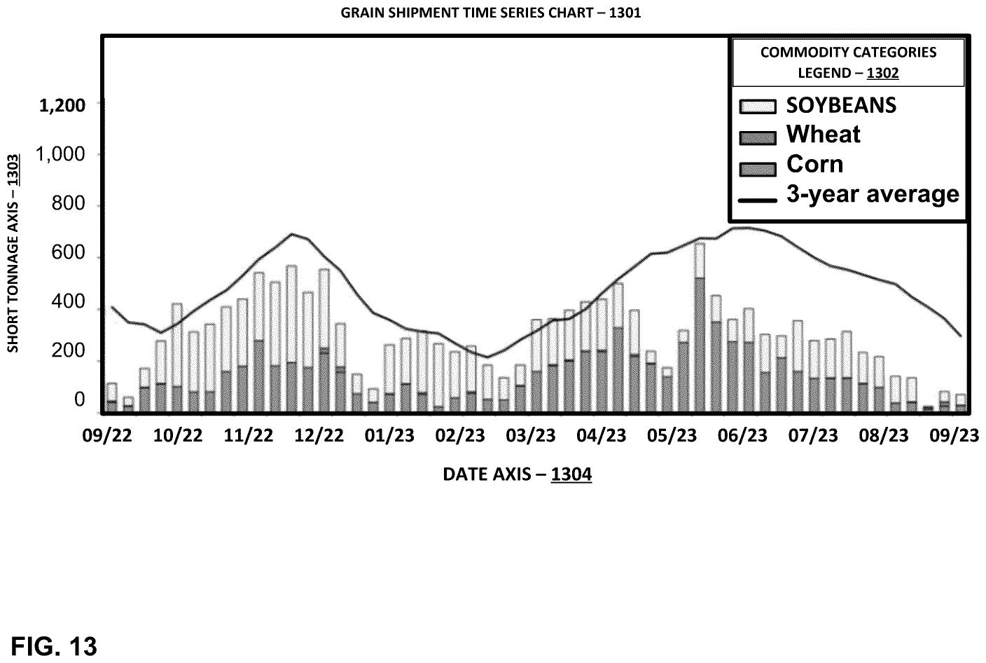

FIG. 13 depicts grain shipment time series chart 1301, which illustrates barge movements on the Mississippi River based on data from Locks 27 in Granite City, Illinois, in accordance with aspects of this disclosure. Grain shipment time series chart 1301 shows the impact of agricultural bulk commodity transportation in a seasonal global market. Grain shipment time series chart 1301 includes commodity categories legend 1302, which displays data categories for soybeans, wheat, and corn, as well as the 3-year average trend line. Grain shipment time series chart 1301 includes short tonnage axis 1303, which presents shipment volumes measured in 1,000 short tons ranging from 0 to 1,200. Grain shipment time series chart 1301 includes date axis 1304, which represents a timeline spanning from September 2022 through September 2023, simplified to monthly intervals. The 3-year average line is calculated using a 4-week moving average. The data source is the U.S. Army Corps of Engineers, which has recently migrated its lock and vessel database, with potential revisions expected. The Mississippi River transports over 60% of the United States' soybean and corn exports. Soybean shipping primarily relies on barge transport, while corn shipments include both barge and domestic biofuel refinery consumption. Limited grain storage capacity leads to a concentrated shipping period following harvest season, typically from September to November, which often coincides with periods of low water levels on the Mississippi River.

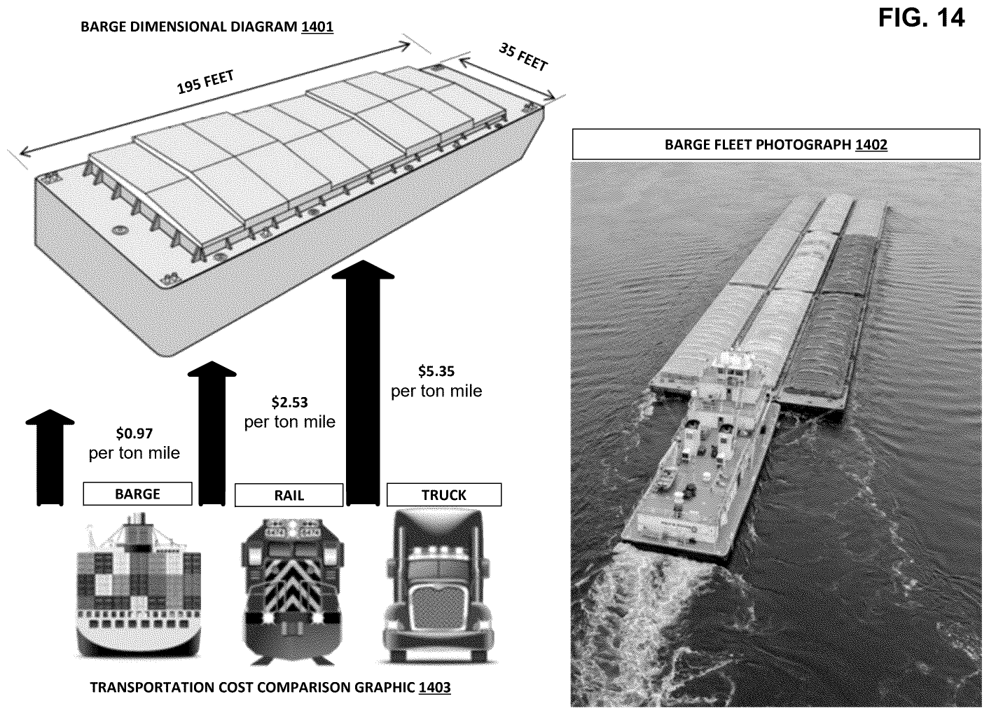

FIG. 14 depicts example barge shipping infrastructure and transportation cost comparisons, in accordance with aspects of this disclosure. FIG. 14 includes barge dimensional diagram 1401, which shows a standard Mississippi River barge with a length of 195 feet and a width of 35 feet. Barge dimensional diagram 1401 illustrates cargo hold covers and depicts the approximate layout of a typical unpowered flat-bottom barge, which can be arranged into a fleet and pushed by a dedicated towboat. A standard barge as shown in barge dimensional diagram 1401 can carry approximately 1,500 short tons of cargo. FIG. 14 includes barge fleet photograph 1402, which shows an example river tow including multiple barges aligned in rows and columns, being propelled by a push boat along the waterway. The barge fleet shown in barge fleet photograph 1402 represents an arrangement typical of inland waterway freight transport, where unpowered barges are grouped into tows for efficiency.

FIG. 14 further includes transportation cost comparison graphic 1403. Transportation cost comparison graphic 1403 presents cost per ton mile for three transportation modes: barge, rail, and truck. Transportation cost comparison graphic 1403 indicates that barge transportation costs approximately $0.97 per ton mile, rail transportation costs approximately $2.53 per ton mile, and truck transportation costs approximately $5.35 per ton mile. Transportation cost comparison graphic 1403 illustrates that one standard river tow of fifteen barges carries cargo equivalent to approximately 1,050 trucks or 216 rail cars with six locomotives. Transportation cost comparison graphic 1403 highlights the comparative efficiency of barge freight for transporting bulk commodities at reduced per ton mile costs.

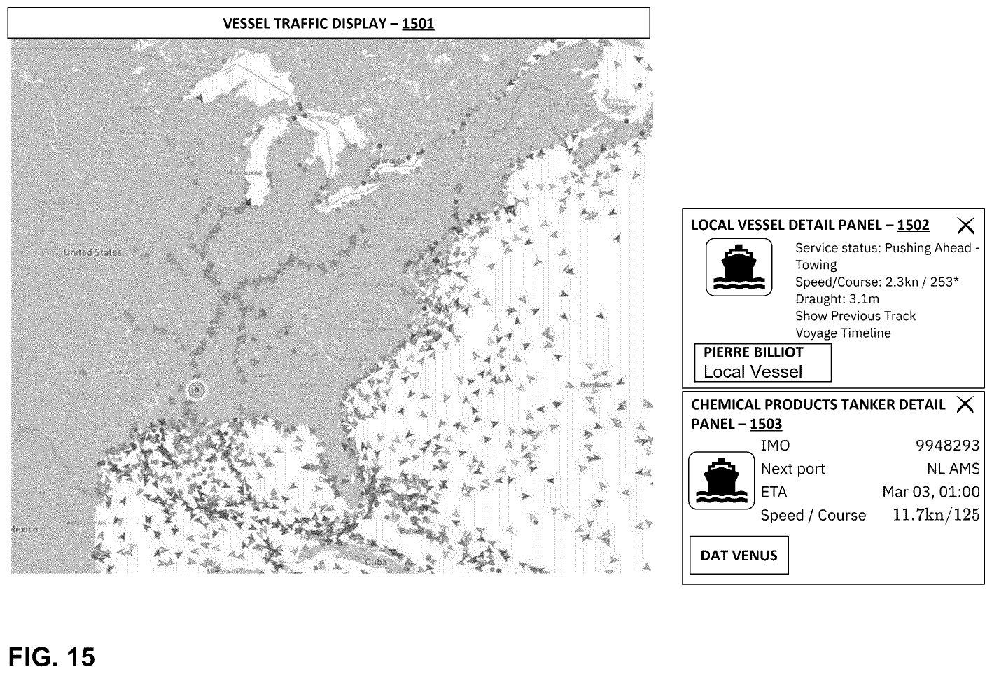

FIG. 15 depicts limitations on marine AIS data for barge traffic, in accordance with aspects of this disclosure. FIG. 15 includes vessel traffic display 1501. Vessel traffic display 1501 shows marine traffic across the United States inland waterways, coastal ports, and offshore shipping lanes. FIG. 15 includes local vessel detail panel 1502, which provides vessel-specific information for a local vessel named Pierre Billiot. Local vessel detail panel 1502 includes data such as service status, towing activity, speed and course, draught, and voyage tracking options. FIG. 15 also includes chemical products tanker detail panel 1503, which provides vessel-specific information for a chemical products tanker named Dat Venus. Chemical products tanker detail panel 1503 displays data including International Maritime Organization (IMO) number, next port of call, estimated time of arrival, and vessel speed and course. Vessel traffic display 1501 demonstrates that while AIS systems can capture barge and tanker location data, certain inland traffic may be underrepresented or lack detailed coverage due to infrastructure and reporting limitations.

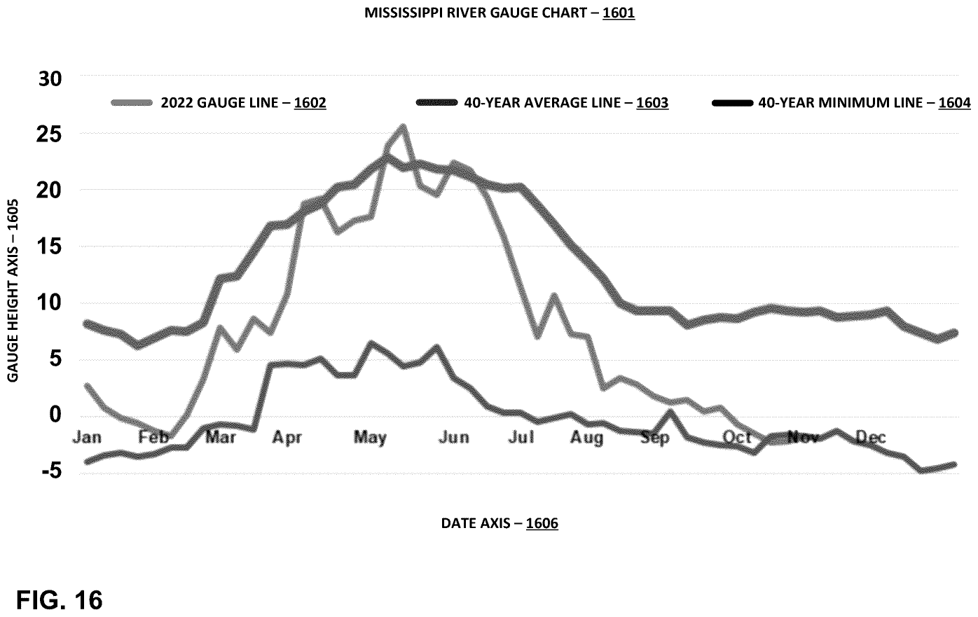

FIG. 16 illustrates Mississippi river gauge chart 1601, in accordance with aspects of this disclosure. Mississippi river gauge chart 1601 displays river gauge height data in fect for St. Louis, Missouri. Mississippi river gauge chart 1601 includes 2022 gauge line 1602, which shows the recorded river gauge heights during the 2022 season. Mississippi river gauge chart 1601 further includes 40-year average line 1603, representing the historical average gauge height over the past 40 years. Mississippi river gauge chart 1601 also includes 40-year minimum line 1604, which represents the minimum recorded gauge heights across the 40-year historical record.

Mississippi river gauge chart 1601 is annotated with gauge height axis 1605, providing the vertical scale in fect, ranging from negative five feet to thirty feet. Mississippi river gauge chart 1601 also includes date axis 1606, providing the horizontal scale across the calendar year from January to December.

Mississippi river gauge chart 1601 highlights the 2022 and 2023 Mississippi drought events by showing the divergence of 2022 gauge line 1602 from 40-year average line 1603 and 40-year minimum line 1604, particularly during low water periods in late summer and fall.

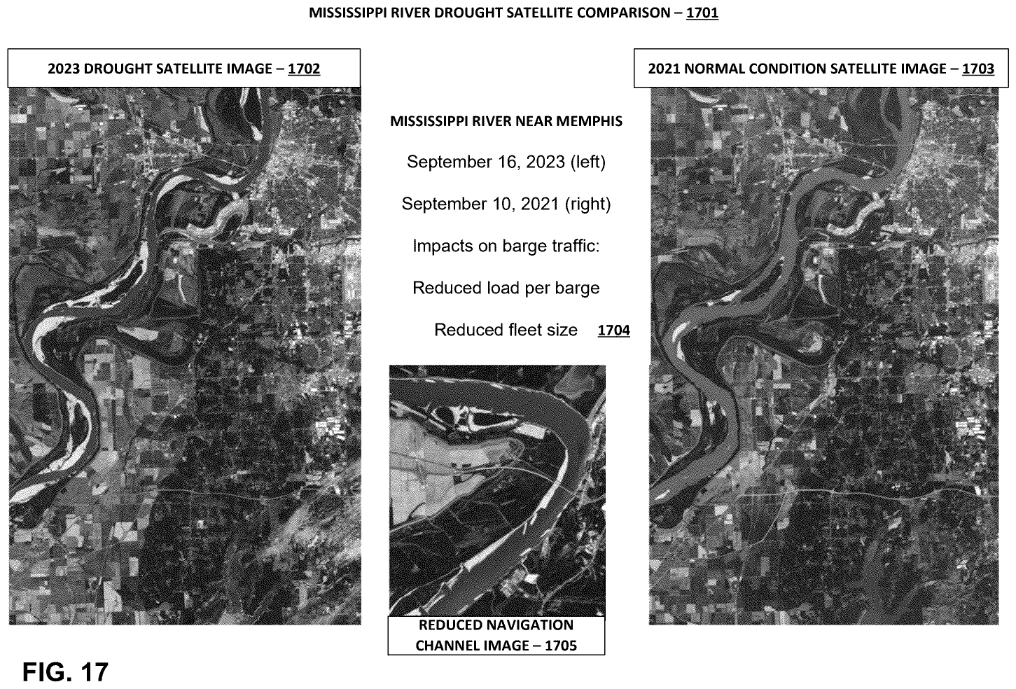

FIG. 17 depicts seasonal impacts on the Mississippi River near Memphis, Tennessee, including impacts on barge traffic, in accordance with aspects of this disclosure. FIG. 17 includes Mississippi River drought satellite comparison 1701. Mississippi River drought satellite comparison 1701 illustrates differences in river conditions between a drought year and a normal year. FIG. 17 includes 2023 drought satellite image 1702, which shows the Mississippi River near Memphis on Sep. 16, 2023, during low water conditions. FIG. 17 further includes 2021 normal condition satellite image 1703, which shows the Mississippi River near Memphis on Sep. 10, 2021, under normal water conditions.

FIG. 17 includes reduced fleet size 1704, which indicates operational impacts of low river levels on barge shipping. Specifically, reduced fleet size 1704 reflects that drought conditions cause shipping operators to reduce both the load per barge and the number of barges per fleet. FIG. 17 also includes reduced navigation channel image 1705, which shows a close-up satellite view of the Mississippi River channel during drought conditions, illustrating visibly narrower navigation lanes.

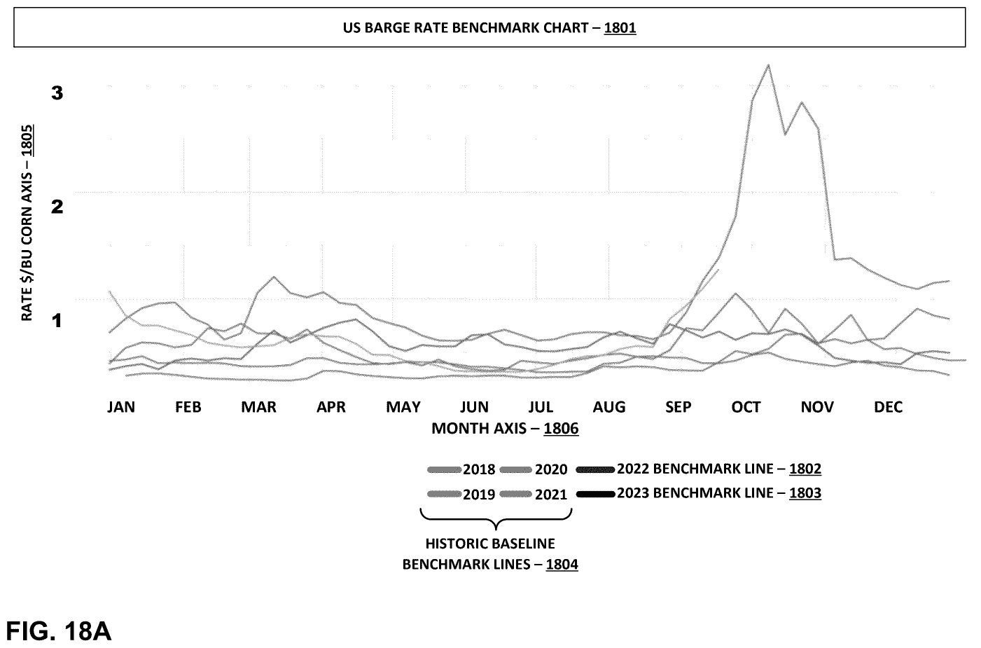

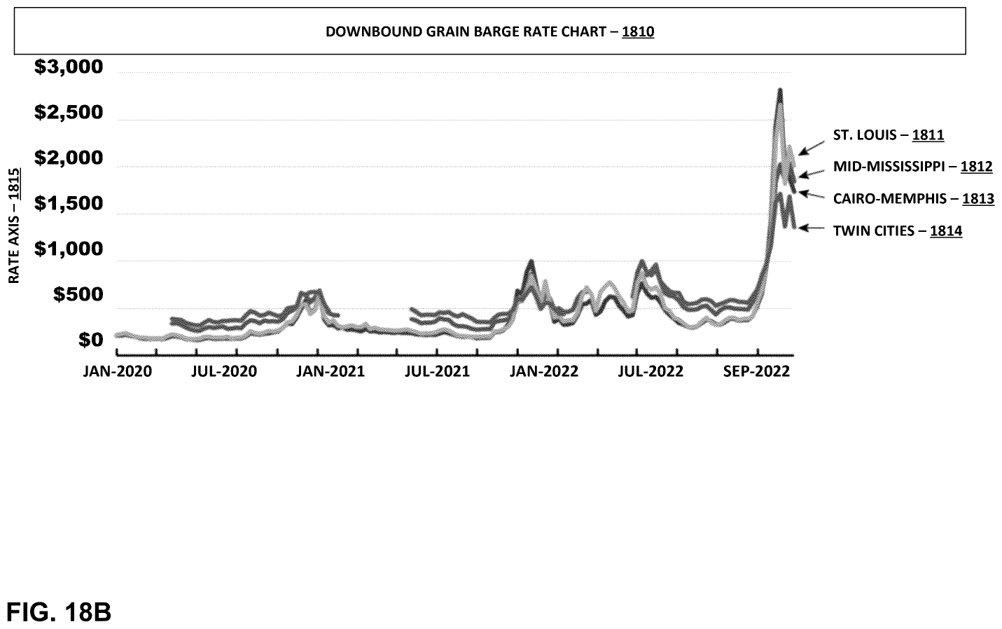

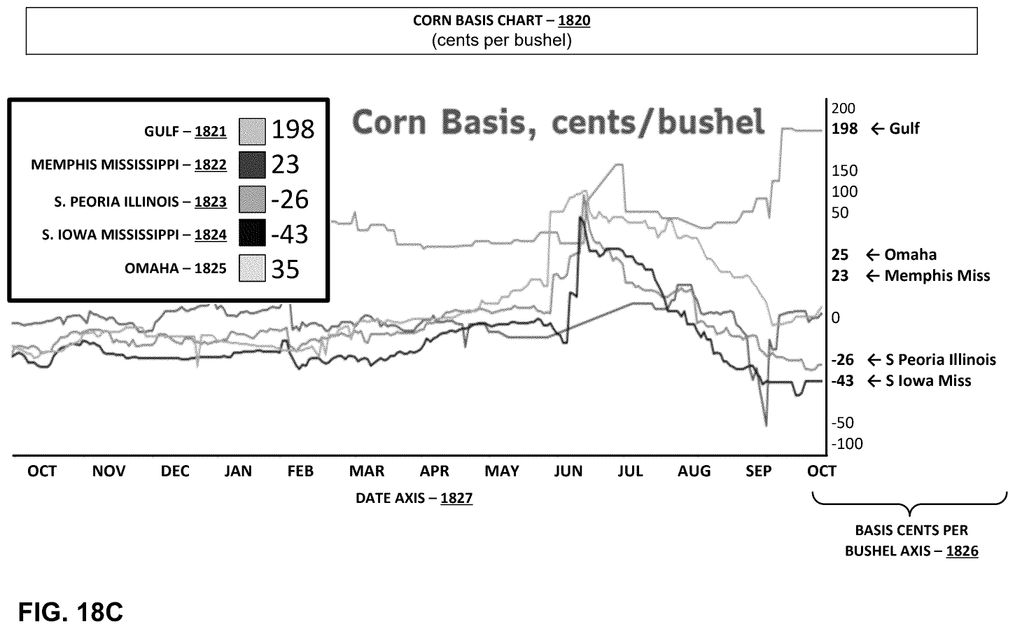

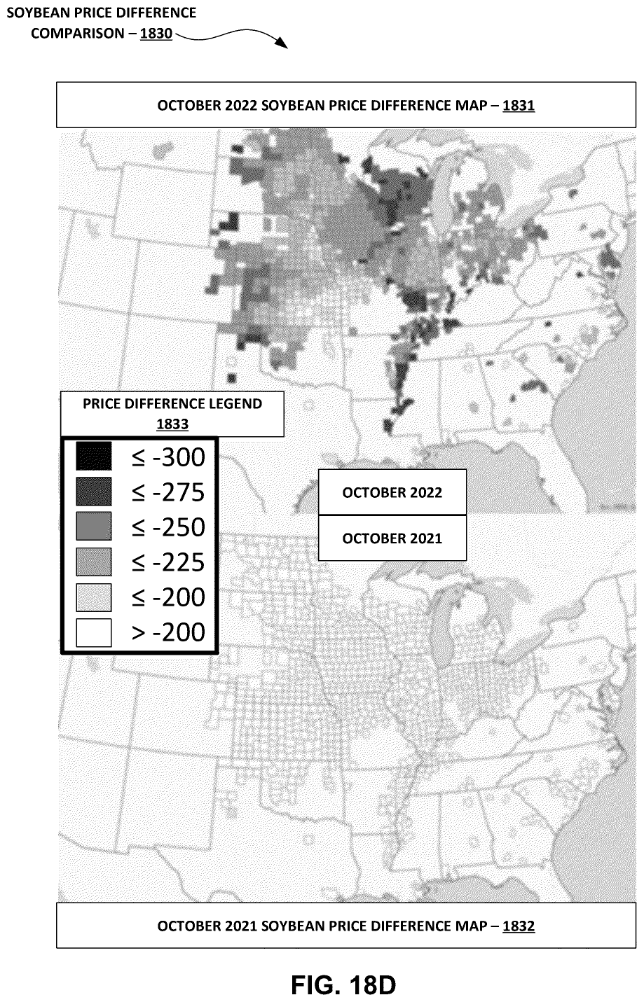

FIGS. 18A, 18B, 18C, and 18D depict agricultural supply chain disruptions and price shocks, in accordance with aspects of this disclosure. FIG. 18A includes US barge rate benchmark chart 1801. US barge rate benchmark chart 1801 displays rate $/bu corn axis 1805 on the vertical axis and month axis 1806 on the horizontal axis. US barge rate benchmark chart 1801 includes 2022 benchmark line 1802 and 2023 benchmark line 1803. US barge rate benchmark chart 1801 further includes historic baseline benchmark lines 1804 corresponding to a set of baseline years for comparison.

FIG. 18B includes downbound grain barge rate chart 1810. Downbound grain barge rate chart 1810 displays rate axis 1815 on the vertical axis and time progression over multiple years on the horizontal axis. Downbound grain barge rate chart 1810 includes regional lines labeled as St. Louis 1811, Mid-Mississippi 1812, Cairo-Memphis 1813, and Twin Cities 1814, showing different downbound grain barge rates by region.

FIG. 18C includes corn basis chart 1820. Corn basis chart 1820 displays basis cents per bushel axis 1826 on the vertical axis and date axis 1827 on the horizontal axis. Corn basis chart 1820 includes Gulf 1821, Memphis Mississippi 1822, South Peoria Illinois 1823, South Iowa Mississippi 1824, and Omaha 1825. Corn basis chart 1820 represents basis data, with each location corresponding to a specific line in the chart. The term “basis” refers to the local cash price of corn minus the futures price, and corn basis chart 1820 visualizes these differences across various regions.

FIG. 18D includes soybean price difference comparison 1830. Soybean price difference comparison 1830 includes October 2022 soybean price difference map 1831 and October 2021 soybean price difference map 1832. Soybean price difference comparison 1830 further includes price difference legend 1833, which displays color-coded ranges for price differences: ≤−300, ≤−275, ≤−250, ≤−225, ≤−200, and >−200.

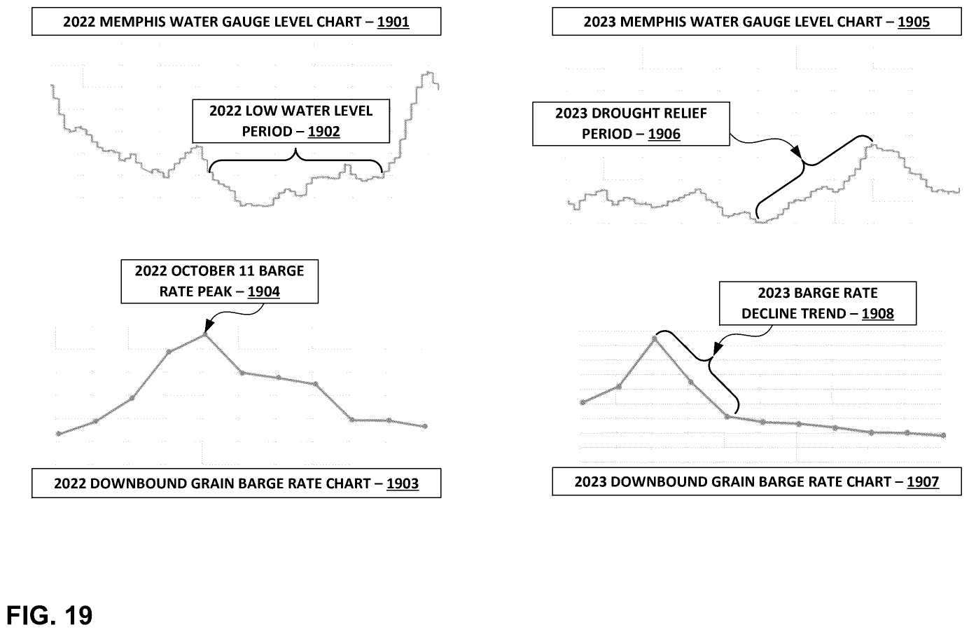

FIG. 19 depicts different temporal patterns of the 2022 and 2023 droughts, in accordance with aspects of this disclosure. FIG. 19 includes 2022 Memphis water gauge level chart 1901 and 2023 Memphis water gauge level chart 1905. 2022 Memphis water gauge level chart 1901 shows 2022 low water level period 1902. 2023 Memphis water gauge level chart 1905 shows 2023 drought relief period 1906.

FIG. 19 further includes 2022 downbound grain barge rate chart 1903 and 2023 downbound grain barge rate chart 1907. 2022 downbound grain barge rate chart 1903 shows 2022 Oct. 11 barge rate peak 1904. 2023 downbound grain barge rate chart 1907 shows 2023 barge rate decline trend 1908.

Developing a near-real time barge traffic monitoring system based on high-resolution satellite remote sensing imagery for agricultural supply chain disruptions may help mitigate drought impacts. The system may provide timely information compared to existing USDA reports, which have a one-week to ten-day delay. The system may also provide spatially distributed information along sections of the Mississippi River and navigable tributaries, compared to USDA reports typically available only for the Upper Mississippi. Such information may be targeted for specific users, including agricultural traders, agricultural futures markets, insurance providers, and agricultural supply chain components.

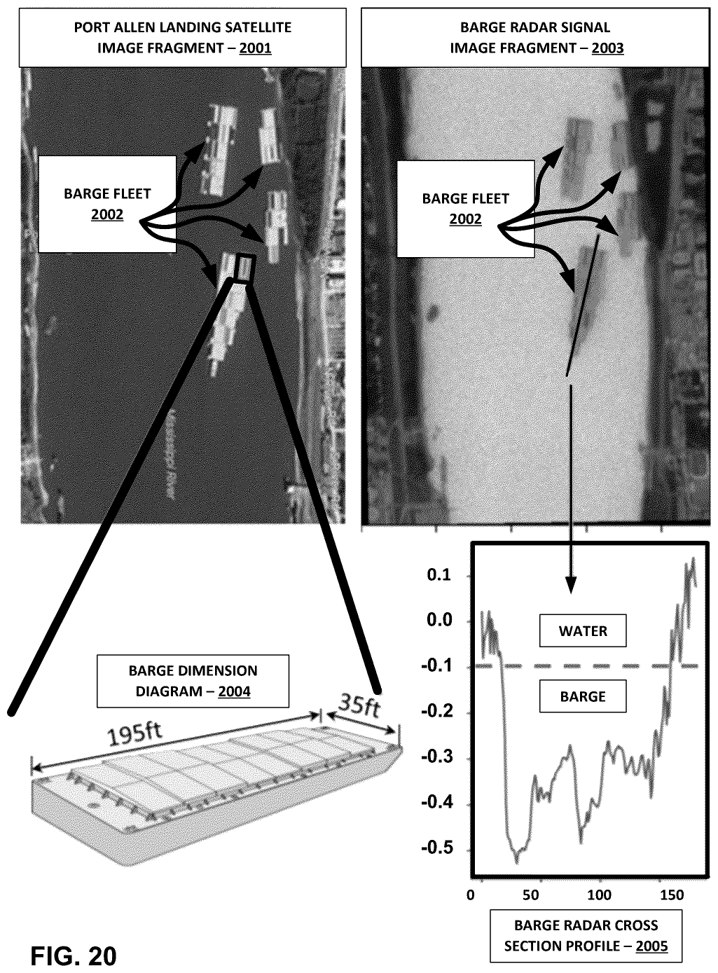

FIG. 20 depicts different example planet imagery data providing binary classification of water surfaces and non-water surfaces, in accordance with aspects of this disclosure. Binary classification of water surfaces and non-water surfaces refers to the process of separating radar and optical signal data into regions corresponding to water areas and regions corresponding to non-water objects such as barges or vessels.

Port Allen Landing Satellite Image Fragment 2001 includes Barge Fleet 2002, where each barge is visible as rectangular objects aligned together on the Mississippi River. Barge Radar Signal Image Fragment 2003 also includes Barge Fleet 2002, where radar signal contrast distinguishes the barge surfaces from the surrounding water based on signal backscatter intensity. Barge Dimension Diagram 2004 illustrates the standard barge unit with dimensions of 195 fect by 35 feet, consistent with typical inland waterway barge specifications. Barge Radar Cross Section Profile 2005 shows a radar signal profile across a barge, with the radar return from the water surface displayed at approximately zero level, while the radar return from Barge Fleet 2002 is shown as a lower signal due to different reflectance characteristics. This combined data enables binary classification of water surfaces and non-water surfaces using both optical and radar datasets for barge fleet detection and monitoring.

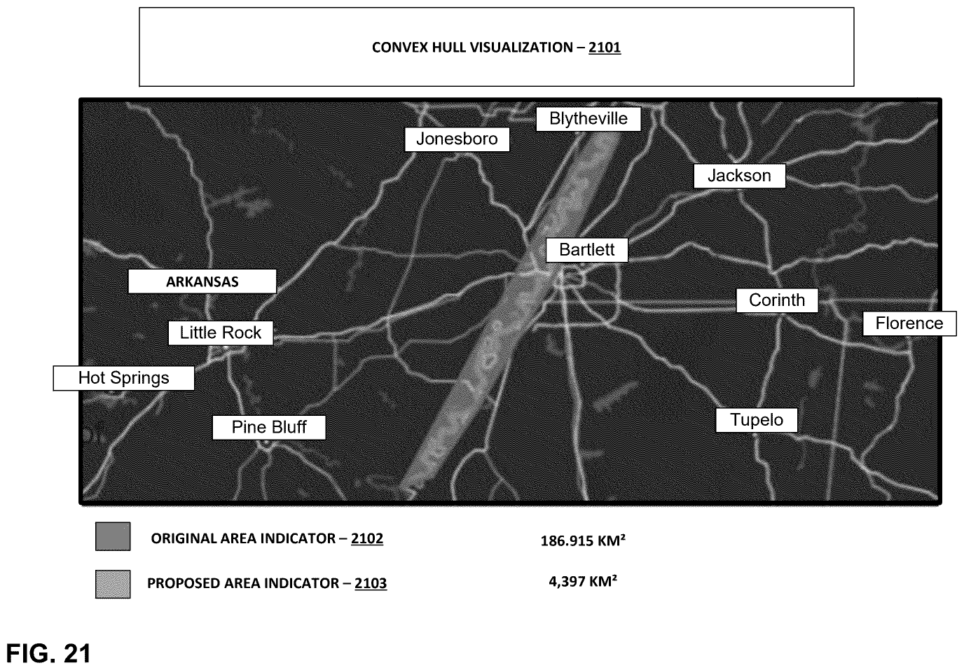

FIG. 21 depicts convex hull visualization 2101 applied to portions of planet imagery data collection, in accordance with aspects of this disclosure. The convex hull visualization 2101 illustrates a geometric approximation of the region by using a mathematical convex hull technique, where the geometry has been approximated by taking a “rubber band” around all of the points. The convex hull visualization 2101 includes a representation of the Upper Mississippi River and Lower Mississippi River. The Upper Mississippi River has a navigable length of approximately 850 miles (1,370 km), extending from Minneapolis to the confluence with the Ohio River. The Lower Mississippi River is about 1,000 miles in length.

The convex hull visualization 2101 specifically depicts the waterway phase near Memphis, Tennessee, including a navigable segment of 382 km. The convex hull visualization 2101 further includes an original area indicator 2102 representing the original area of interest, labeled as 186.915 km² in the figure. The convex hull visualization 2101 also includes a proposed area indicator 2103 representing the expanded area of interest, labeled as 4,397 km² in the figure.

The convex hull visualization 2101 includes labels for geographic locations, including Arkansas, Little Rock, Hot Springs, Pine Bluff, Jonesboro, Blytheville, Bartlett, Jackson, Corinth, Florence, and Tupelo, to provide context for the region covered by the original area indicator 2102 and the proposed area indicator 2103.

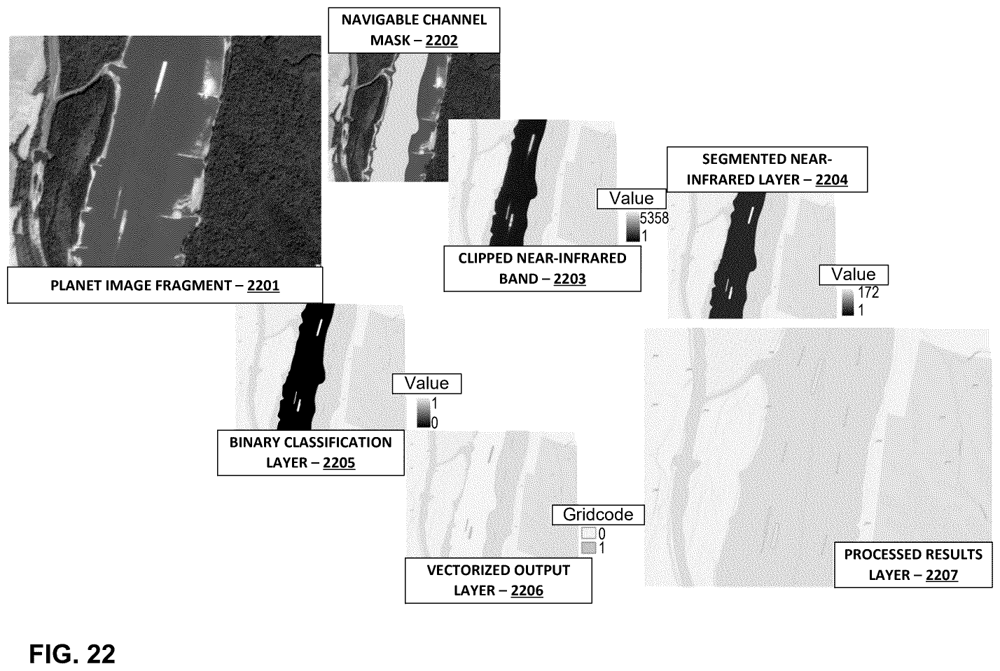

FIG. 22 depicts the pipelined workflow performed by barge tracking framework 170, in accordance with aspects of this disclosure. The pipelined workflow starts with planet image fragment 2201. Planet image fragment 2201 shows a satellite image of a river region including visible barge traffic. From planet image fragment 2201, navigable channel mask 2202 is generated. Navigable channel mask 2202 identifies the portion of the river suitable for navigation by waterborne vessels.

Next, clipped near-infrared band 2203 is produced from navigable channel mask 2202 by isolating the relevant spectral information corresponding to the near-infrared range. Clipped near-infrared band 2203 is used to generate segmented near-infrared layer 2204. Segmented near-infrared layer 2204 applies a segmentation process that separates different regions in clipped near-infrared band 2203 based on spectral characteristics.

Segmented near-infrared layer 2204 is processed to generate binary classification layer 2205. Binary classification layer 2205 applies a threshold-based classification to identify pixels corresponding to water and non-water surfaces, with a binary indicator assigned to each pixel location.

Binary classification layer 2205 is then converted into vectorized output layer 2206. Vectorized output layer 2206 represents the classified regions in vector format, allowing for spatial analysis and integration with other geospatial data layers.

Finally, vectorized output layer 2206 is refined into processed results layer 2207. Processed results layer 2207 shows the final output of the pipelined workflow, with cleaned and smoothed representations of the navigable channel and barge locations derived from planet image fragment 2201 through successive transformations.

The workflow of FIG. 22 demonstrates a barge tracking and water surface monitoring method that uses planet image fragment 2201, navigable channel mask 2202, clipped near-infrared band 2203, segmented near-infrared layer 2204, binary classification layer 2205, vectorized output layer 2206, and processed results layer 2207 to achieve efficient tracking of waterborne traffic and river surface classification.

In certain examples, the barge tracking workflow described in FIG. 22 may be configured to operate in a dynamic, rolling update mode. For instance, new satellite imagery data may be automatically processed as it becomes available, with the navigable channel mask, near-infrared band, segmentation, classification, vectorization, and output refinement steps performed incrementally. This allows for continuous or near real-time monitoring of river traffic conditions without requiring full batch reprocessing of historical data. The system can maintain a pipeline where updated imagery inputs are processed on an ongoing basis, providing refreshed traffic monitoring results and enabling the detection of changes such as barge movement, fleet formation, or congestion events in a timely manner.

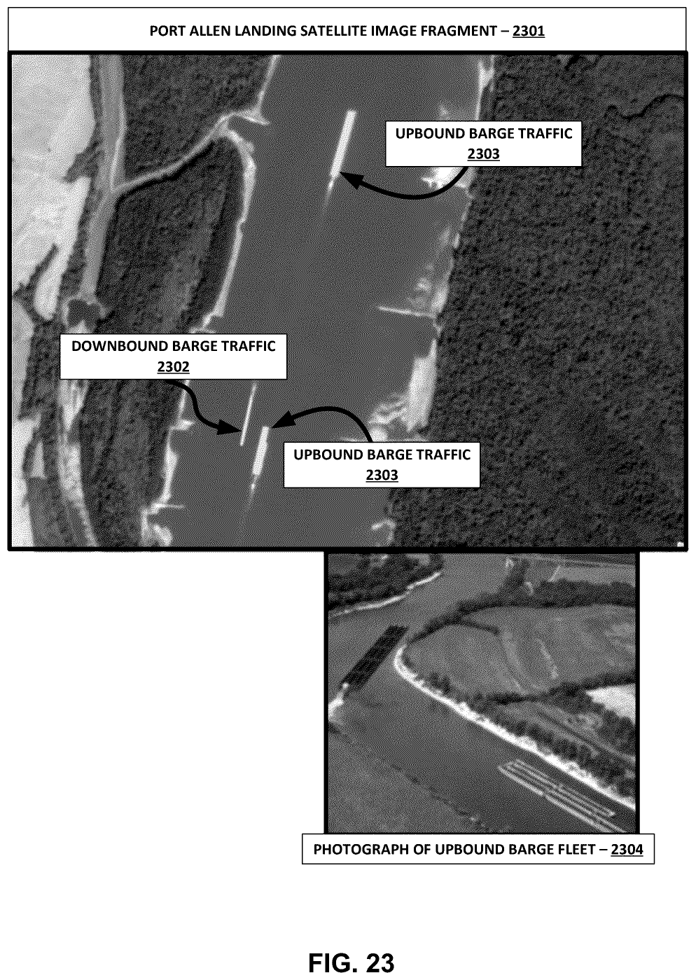

FIG. 23 depicts validation and labeling performed by barge tracking framework 170, in accordance with aspects of this disclosure. In particular, barge tracking framework 170 may provide a database of barge monitoring including time and location information, fleet size indicating the number of barges, and travel direction indicating upbound travel, downbound travel, or parking status. Such information may be overlapped with other maps and summarized by barge tracking framework 170 per user requirements, for example, downbound traffic between Cairo and Memphis. In some examples, barge traffic monitoring outputs can be used by agricultural commodities traders, futures markets, or insurance companies to assess supply chain risks, forecast freight transport capacity, and evaluate potential impacts of hydrologic conditions on pricing or logistics. The data can inform decision-making processes for financial markets and agricultural logistics planning, particularly during seasonal disruptions or drought events. In other examples, the system may provide sectional traffic summaries that correspond to specific river segments between ports, trading hubs, or logistics centers. These sectional summaries enable regionally tailored decision support, allowing users to monitor localized traffic conditions along selected portions of the inland waterway network. For example, traffic density or fleet size may be summarized separately for different river segments to assist with logistical planning or congestion monitoring.

In various examples, the validation and labeling outputs can be further utilized to improve the accuracy and performance of the barge detection workflow. For instance, labeled data collected during validation may be stored as part of a training dataset for refining machine learning models or adjusting rule-based filters used in barge detection. The system may support human-in-the-loop correction, where operators verify or correct detected barge features, and the corrected data is incorporated into training data for future model updates. Historical datasets, such as prior satellite imagery with confirmed barge locations or ground truth data from lock reports, may also be integrated into the training process to calibrate detection thresholds or refine classification logic. This adaptive approach allows the system to iteratively improve detection accuracy over time.

FIG. 23 includes Port Allen landing satellite image fragment 2301. Port Allen landing satellite image fragment 2301 contains downbound barge traffic 2302 and upbound barge traffic 2303. Downbound barge traffic 2302 is shown moving toward the lower portion of Port Allen landing satellite image fragment 2301. Upbound barge traffic 2303 is shown in two locations within Port Allen landing satellite image fragment 2301, moving in the direction opposite of downbound barge traffic 2302.

FIG. 23 also includes photograph of upbound barge fleet 2304. Photograph of upbound barge fleet 2304 shows a real-world visual example of upbound barge traffic corresponding to the monitored traffic in Port Allen landing satellite image fragment 2301.

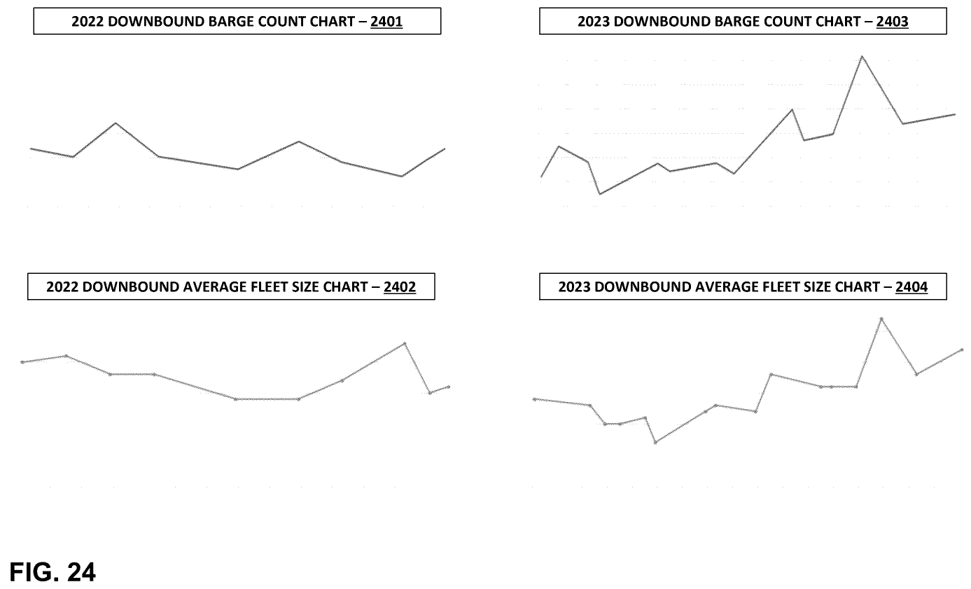

FIG. 24 depicts an example of barge numbers and a fleet size summary provided by barge tracking framework 170, in accordance with aspects of this disclosure. FIG. 24 includes 2022 downbound barge count chart 2401, 2022 downbound average fleet size chart 2402, 2023 downbound barge count chart 2403, and 2023 downbound average fleet size chart 2404.

2022 downbound barge count chart 2401 shows the number of downbound barge movements for the year 2022, measured during the main harvest shipping window. The chart indicates lower barge traffic levels compared to historical averages, consistent with the impacts of the 2022 drought. The count fluctuates over the period shown, but overall remains suppressed.

2022 downbound average fleet size chart 2402 depicts the average number of barges per fleet moving downbound during 2022. The chart shows that fleet sizes decreased over the shipping window as water levels remained low and navigation constraints persisted. The smaller fleet sizes reflect the operational adjustments made by barge operators in response to river conditions.

2023 downbound barge count chart 2403 displays the number of downbound barge movements for the year 2023. The chart indicates an initially low barge count due to continued drought impacts at the start of the season. However, the data show progressive recovery as the river system improved, resulting in increased traffic through the shipping window.

2023 downbound average fleet size chart 2404 presents the average number of barges per fleet for downbound traffic in 2023. The chart illustrates that while early-season fleet sizes remained small, later periods of 2023 saw increasing fleet sizes as river conditions stabilized and drought relief occurred in the upper basin. This trend contrasts with the 2022 pattern of persistent small fleet sizes.

Barge tracking framework 170 can provide data summaries of barge count and fleet size such as those presented in 2022 downbound barge count chart 2401, 2022 downbound average fleet size chart 2402, 2023 downbound barge count chart 2403, and 2023 downbound average fleet size chart 2404. Such summaries may assist users in monitoring river logistics, market conditions, and supply chain impacts.

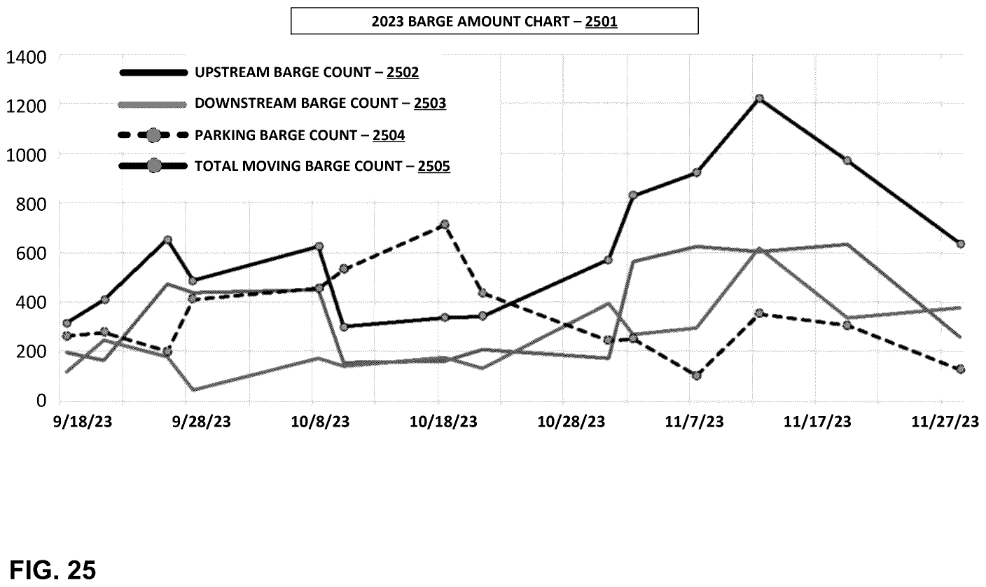

FIG. 25 depicts an example of categorical barge traffic types for detailed analysis as provided by barge tracking framework 170, in accordance with aspects of this disclosure. Barge tracking framework 170 may be adapted to work with the Mississippi River Transportation System or other river transportation systems. Larger domain examples include the Upper Mississippi River, tributaries such as the Ohio River and the Illinois River, and other regions closer to agricultural producers that are more prone to drought impacts. These regions may be targeted for service to provide enhanced data to market actors. Detailed spatial resolution for decision making may be provided to market actors by barge tracking framework 170. For instance, barge tracking framework 170 may provide a summary by river sections between ports, markets, and logistic hubs, so as to provide tailored information for different users.

FIG. 25 includes 2023 barge amount chart 2501. 2023 barge amount chart 2501 includes upstream barge count 2502, downstream barge count 2503, parking barge count 2504, and total moving barge count 2505. Upstream barge count 2502 represents the number of barges detected moving in the upstream direction for each observation date during the two-month shipping window. Downstream barge count 2503 represents the number of barges detected moving in the downstream direction for each observation date during the two-month shipping window. Parking barge count 2504 represents the number of barges identified as stationary or parked for each observation date during the two-month shipping window. Total moving barge count 2505 represents the combined total of upstream barge count 2502 and downstream barge count 2503 for each observation date during the two-month shipping window.

Artificial intelligence may be applied to barge detection analytics using the labeled results from 2023 barge amount chart 2501 to generate predictive output. This predictive output may be accessible via a web interface, such as through a Planet API or other suitable delivery platform, to enable smooth information delivery and integration for end users.

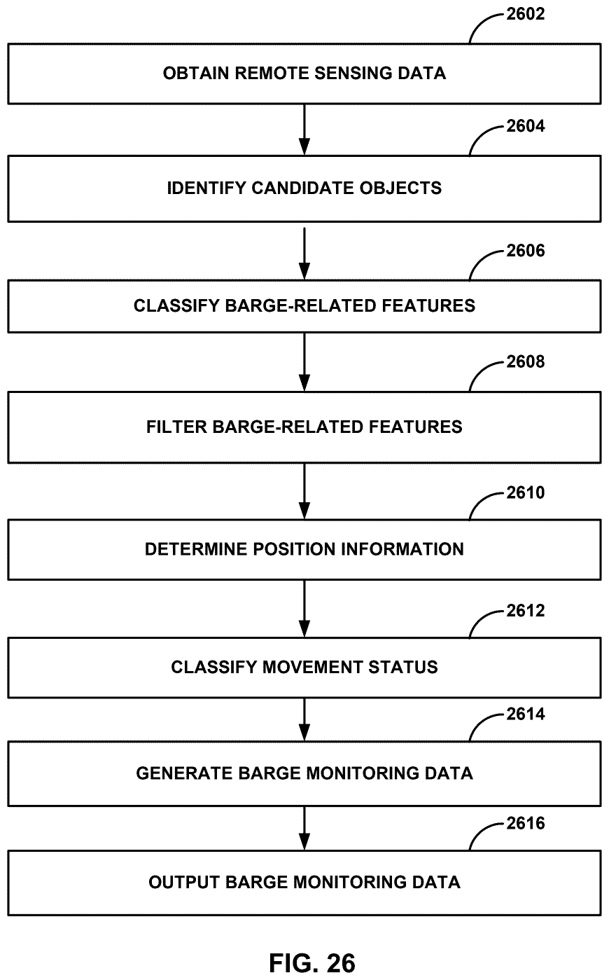

FIG. 26 is a flow diagram illustrating an example method for detecting, classifying, and monitoring barge traffic in inland waterways using remote sensing data, in accordance with aspects of this disclosure. FIG. 26 is described with respect to computing device 100, examples of processing circuitry, and systems configured to process remote sensing data as discussed in relation to FIGS. 1-25. However, the techniques of FIG. 26 may be performed by different components of computing device 100 or by additional or alternative systems.

Processing circuitry of computing device 100 may be configured to obtain remote sensing data (2602). For example, the processing circuitry may be configured to obtain remote sensing data representing at least a portion of a waterway region.

Processing circuitry of computing device 100 may be configured to identify candidate objects (2604). For example, the processing circuitry may be configured to process the remote sensing data to identify candidate objects within the waterway region.

Processing circuitry of computing device 100 may be configured to classify barge-related features (2606). For example, the processing circuitry may be configured to classify the candidate objects to differentiate barge-related features from other features in the waterway region.

Processing circuitry of computing device 100 may be configured to filter barge-related features (2608). For example, the processing circuitry may be configured to filter the barge-related features based on one or more criteria to produce filtered barge-related features.

Processing circuitry of computing device 100 may be configured to determine position information (2610). For example, the processing circuitry may be configured to determine position information for the filtered barge-related features.

Processing circuitry of computing device 100 may be configured to classify movement status (2612). For example, the processing circuitry may be configured to classify a movement status of the filtered barge-related features based on the position information, wherein the movement status indicates at least one of: upbound, downbound, or stationary.

Processing circuitry of computing device 100 may be configured to generate barge monitoring data (2614). For example, the processing circuitry may be configured to generate barge monitoring data including the filtered barge-related features, the position information, and the movement status.

Processing circuitry of computing device 100 may be configured to output barge monitoring data (2616). For example, the processing circuitry may be configured to output the barge monitoring data in response to classifying the movement status of the filtered barge-related features.

In this way, FIG. 26 illustrates an example process for obtaining and processing remote sensing data to detect and monitor barge traffic in inland waterways. The disclosed techniques enable automated, near real-time barge tracking without reliance on onboard equipment or manual observation, facilitating comprehensive monitoring of both motorized and non-motorized vessels for applications in logistics, environmental management, and transportation infrastructure planning.

This disclosure includes the following examples.

Example 1-A computer-implemented method comprising: obtaining, using processing circuitry, remote sensing data representing at least a portion of a waterway region; processing, using the processing circuitry, the remote sensing data to identify candidate objects within the waterway region; classifying, using the processing circuitry, the candidate objects to differentiate barge-related features from other features in the waterway region; filtering, using the processing circuitry, the barge-related features based on one or more criteria to produce filtered barge-related features; determining, using the processing circuitry, position information for the filtered barge-related features; classifying, using the processing circuitry, a movement status of the filtered barge-related features based on the position information, wherein the movement status indicates at least one of: upbound, downbound, or stationary; and in response to classifying the movement status of the filtered barge-related features, outputting, using the processing circuitry, barge monitoring data including the filtered barge-related features, the position information, and the movement status.

Example 2—The method of example 1, wherein the processing of the remote sensing data to identify candidate objects, the classifying of the candidate objects, the filtering of the barge-related features, or the determining of the position information further comprises: using the Near-Infrared band from the multispectral satellite imagery.

Example 3—The method of example 2, further comprising: applying a navigable waterway mask to the multispectral satellite imagery to isolate the waterway region from surrounding land areas, wherein the applying of the navigable waterway mask further comprises using the isolated waterway region in at least one of the processing of the remote sensing data to identify candidate objects, the classifying of the candidate objects, the filtering of the barge-related features, or the determining of the position information.

Example 4—The method of example 3, further comprising: extracting the Near-Infrared band and generating a grayscale image of the Near-Infrared band to enhance contrast between water surfaces and non-water surfaces.

Example 5—The method of example 4, further comprising: segmenting the grayscale image of the Near-Infrared band to generate partitioned regions corresponding to barge-related features and river features.

Example 6—The method of example 5, further comprising: applying a thresholding operation to convert the partitioned regions into a binary mask, wherein the binary mask includes a first class of pixels representing barge-related features and a second class of pixels representing river features.

Example 7—The method of example 6, further comprising: transforming contiguous groups of the first class of pixels into polygonal vector features corresponding to barge bounding rectangles.

Example 8—The method of example 7, further comprising: removing polygonal vector features having an area less than 200 square meters or greater than 100,000 square meters.

Example 9—The method of example 1, further comprising: determining centroid points for the filtered barge-related features as part of the position information.

Example 10—The method of example 1, wherein classifying the movement status comprises comparing the position information of the filtered barge-related features over time to determine a direction of movement.

Example 11—The method of example 1, further comprising: in response to outputting the barge monitoring data, transmitting the barge monitoring data to a remote computing device for visualization or further analysis.

Example 12—The method of example 1, wherein the barge monitoring data includes: a fleet size determination indicating a number of barges per fleet; a summary of barge counts categorized by upstream movement, downstream movement, and stationary parking status; and a feature class including both polygonal vector features corresponding to barge bounding rectangles prior to filtering and polygonal vector features corresponding to barge bounding rectangles after filtering.

Example 13-A system comprising: processing circuitry; non-transitory computer readable media; and instructions that, when executed by the processing circuitry, configure the processing circuitry to: obtain remote sensing data representing at least a portion of a waterway region; process the remote sensing data to identify candidate objects within the waterway region; classify the candidate objects to differentiate barge-related features from other features in the waterway region; filter the barge-related features based on one or more criteria to produce filtered barge-related features; determine position information for the filtered barge-related features; classify a movement status of the filtered barge-related features based on the position information, wherein the movement status indicates at least one of: upbound, downbound, or stationary; and in response to classifying the movement status of the filtered barge-related features, output barge monitoring data including the filtered barge-related features, the position information, and the movement status.

Example 14—The system of example 13, wherein the instructions, when executed by the processing circuitry, further configure the processing circuitry to obtain multispectral satellite imagery including at least a Near-Infrared band.

Example 15—The system of example 14, wherein the instructions, when executed by the processing circuitry, further configure the processing circuitry to apply a navigable waterway mask to the multispectral satellite imagery to isolate the waterway region from surrounding land areas.

Example 16—The system of example 15, wherein the instructions, when executed by the processing circuitry, further configure the processing circuitry to extract the Near-Infrared band and generate a grayscale image of the Near-Infrared band to enhance contrast between water surfaces and non-water surfaces.

Example 17—The system of example 16, wherein the instructions, when executed by the processing circuitry, further configure the processing circuitry to: segment the grayscale image of the Near-Infrared band to generate partitioned regions corresponding to barge-related features and river features; apply a thresholding operation to convert the partitioned regions into a binary mask, wherein the binary mask includes a first class of pixels representing barge-related features and a second class of pixels representing river features; and transform contiguous groups of the first class of pixels into polygonal vector features corresponding to barge bounding rectangles.

Example 18—The system of example 17, wherein the instructions, when executed by the processing circuitry, further configure the processing circuitry to remove polygonal vector features having an area less than 200 square meters or greater than 100,000 square meters.

Example 19—The system of example 13, wherein the instructions, when executed by the processing circuitry, further configure the processing circuitry to: determine centroid points for the filtered barge-related features as part of the position information; classify the movement status by comparing the position information of the filtered barge-related features over time to determine a direction of movement; in response to outputting the barge monitoring data, transmit the barge monitoring data to a remote computing device for visualization or further analysis; and output barge monitoring data including: a fleet size determination indicating a number of barges per fleet; a summary of barge counts categorized by upstream movement, downstream movement, and stationary parking status; and a feature class including both polygonal vector features corresponding to barge bounding rectangles prior to filtering and polygonal vector features corresponding to barge bounding rectangles after filtering.

Example 20-A non-transitory computer-readable storage medium storing instructions that, when executed by processing circuitry, cause the processing circuitry to: obtain remote sensing data representing at least a portion of a waterway region; process the remote sensing data to identify candidate objects within the waterway region; classify the candidate objects to differentiate barge-related features from other features in the waterway region; filter the barge-related features based on one or more criteria to produce filtered barge-related features; determine position information for the filtered barge-related features; classify a movement status of the filtered barge-related features based on the position information, wherein the movement status indicates at least one of: upbound, downbound, or stationary; and in response to classifying the movement status of the filtered barge-related features, output barge monitoring data including the filtered barge-related features, the position information, and the movement status.

Example 21-A computer program product comprising one or more instructions that, when executed by at least one processor, causes the at least one processor to perform any of the methods of examples 1-12.

Example 22-A device comprising means for performing any of the methods of examples 1-12.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A computer-implemented method comprising:
obtaining, using processing circuitry, remote sensing data representing at least a portion of a waterway region;
processing, using the processing circuitry, the remote sensing data to identify candidate objects within the waterway region;
classifying, using the processing circuitry, the candidate objects to differentiate barge-related features from other features in the waterway region;
filtering, using the processing circuitry, the barge-related features based on one or more criteria to produce filtered barge-related features;
determining, using the processing circuitry, position information for the filtered barge-related features;
classifying, using the processing circuitry, a movement status of the filtered barge-related features based on the position information, wherein the movement status indicates at least one of: upbound, downbound, or stationary; and
in response to classifying the movement status of the filtered barge-related features, outputting, using the processing circuitry, barge monitoring data including the filtered barge-related features, the position information, and the movement status.

2. The method of claim 1, wherein the processing of the remote sensing data to identify candidate objects, the classifying of the candidate objects, the filtering of the barge-related features, or the determining of the position information further comprises:
using the Near-Infrared band from the multispectral satellite imagery.

3. The method of claim 2, further comprising:
applying a navigable waterway mask to the multispectral satellite imagery to isolate the waterway region from surrounding land areas, wherein the applying of the navigable waterway mask further comprises using the isolated waterway region in at least one of the processing of the remote sensing data to identify candidate objects, the classifying of the candidate objects, the filtering of the barge-related features, or the determining of the position information.

4. The method of claim 3, further comprising:
extracting the Near-Infrared band and generating a grayscale image of the Near-Infrared band to enhance contrast between water surfaces and non-water surfaces.

5. The method of claim 4, further comprising:
segmenting the grayscale image of the Near-Infrared band to generate partitioned regions corresponding to barge-related features and river features.

6. The method of claim 5, further comprising:
applying a thresholding operation to convert the partitioned regions into a binary mask, wherein the binary mask includes a first class of pixels representing barge-related features and a second class of pixels representing river features.

7. The method of claim 6, further comprising:
transforming contiguous groups of the first class of pixels into polygonal vector features corresponding to barge bounding rectangles.

8. The method of claim 7, further comprising:
removing polygonal vector features having an area less than 200 square meters or greater than 100,000 square meters.

9. The method of claim 1, further comprising:
determining centroid points for the filtered barge-related features as part of the position information.

10. The method of claim 1, wherein classifying the movement status comprises comparing the position information of the filtered barge-related features over time to determine a direction of movement.

11. The method of claim 1, further comprising:
in response to outputting the barge monitoring data, transmitting the barge monitoring data to a remote computing device for visualization or further analysis.

12. The method of claim 1, wherein the barge monitoring data includes:
a fleet size determination indicating a number of barges per fleet;
a summary of barge counts categorized by upstream movement, downstream movement, and stationary parking status; and
a feature class including both polygonal vector features corresponding to barge bounding rectangles prior to filtering and polygonal vector features corresponding to barge bounding rectangles after filtering.

13. A system comprising:
processing circuitry;
non-transitory computer readable media; and
instructions that, when executed by the processing circuitry, configure the processing circuitry to:
obtain remote sensing data representing at least a portion of a waterway region;
process the remote sensing data to identify candidate objects within the waterway region;
classify the candidate objects to differentiate barge-related features from other features in the waterway region;
filter the barge-related features based on one or more criteria to produce filtered barge-related features;
determine position information for the filtered barge-related features;
classify a movement status of the filtered barge-related features based on the position information, wherein the movement status indicates at least one of: upbound, downbound, or stationary; and
in response to classifying the movement status of the filtered barge-related features, output barge monitoring data including the filtered barge-related features, the position information, and the movement status.

14. The system of claim 13, wherein the instructions, when executed by the processing circuitry, further configure the processing circuitry to obtain multispectral satellite imagery including at least a Near-Infrared band.

15. The system of claim 14, wherein the instructions, when executed by the processing circuitry, further configure the processing circuitry to apply a navigable waterway mask to the multispectral satellite imagery to isolate the waterway region from surrounding land areas.

16. The system of claim 15, wherein the instructions, when executed by the processing circuitry, further configure the processing circuitry to extract the Near-Infrared band and generate a grayscale image of the Near-Infrared band to enhance contrast between water surfaces and non-water surfaces.

17. The system of claim 16, wherein the instructions, when executed by the processing circuitry, further configure the processing circuitry to:
segment the grayscale image of the Near-Infrared band to generate partitioned regions corresponding to barge-related features and river features;
apply a thresholding operation to convert the partitioned regions into a binary mask, wherein the binary mask includes a first class of pixels representing barge-related features and a second class of pixels representing river features; and
transform contiguous groups of the first class of pixels into polygonal vector features corresponding to barge bounding rectangles.

18. The system of claim 17, wherein the instructions, when executed by the processing circuitry, further configure the processing circuitry to remove polygonal vector features having an area less than 200 square meters or greater than 100,000 square meters.

19. The system of claim 13, wherein the instructions, when executed by the processing circuitry, further configure the processing circuitry to:
determine centroid points for the filtered barge-related features as part of the position information;
classify the movement status by comparing the position information of the filtered barge-related features over time to determine a direction of movement;
in response to outputting the barge monitoring data, transmit the barge monitoring data to a remote computing device for visualization or further analysis; and
output barge monitoring data including:
a fleet size determination indicating a number of barges per fleet;
a summary of barge counts categorized by upstream movement, downstream movement, and stationary parking status; and
a feature class including both polygonal vector features corresponding to barge bounding rectangles prior to filtering and polygonal vector features corresponding to barge bounding rectangles after filtering.

20. A non-transitory computer-readable storage medium storing instructions that, when executed by processing circuitry, cause the processing circuitry to:
obtain remote sensing data representing at least a portion of a waterway region;
process the remote sensing data to identify candidate objects within the waterway region;
classify the candidate objects to differentiate barge-related features from other features in the waterway region;
filter the barge-related features based on one or more criteria to produce filtered barge-related features;
determine position information for the filtered barge-related features;
classify a movement status of the filtered barge-related features based on the position information, wherein the movement status indicates at least one of: upbound, downbound, or stationary; and
in response to classifying the movement status of the filtered barge-related features, output barge monitoring data including the filtered barge-related features, the position information, and the movement status.
